(19) United States
(12) Patent Application Publication
(10) Pub. No.: US 2014/0129433 A1
(43) Pub. Date: May 8, 2014

(54) METHOD FOR A PAYER TO CHANGE THE FUNDING SOURCE OF A COMPLETED PAYMENT TRANSACTION

(71) Applicant: RONALD JOHN ROSENBERGER, NEWTOWN, PA (US)

(72) Inventor: RONALD JOHN ROSENBERGER, NEWTOWN, PA (US)

(21) Appl. No.: 14/071,440

(22) Filed: Nov. 4, 2013

Related U.S. Application Data
(63) Continuation of application No. 12/665,033, filed on Dec. 16, 2009.
Application No. 12/665,033 is a continuation of application No. PCT/US08/67056, filed on Jun. 15, 2008.
Application No. PCT/US08/67056 is a continuation of application No. 13/956,520, filed on Aug. 1, 2013.
Application No. 13/956,520 is a continuation of application No. 13/779,648, filed on Feb. 27, 2013.
Application No. 13/779,648 is a continuation-in-part of application No. 13/528,750, filed on Jun. 20, 2012.
Application No. 13/528,750 is a continuation of application No. 11/612,467, filed on Dec. 18, 2006, now Pat. No. 8,332,293.
Application No. 11/612,467 is a continuation-in-part of application No. 11/487,680, filed on Jul. 17, 2006, now abandoned.
Application No. 11/487,680 is a continuation-in-part of application No. 10/865,188, filed on Jun. 10, 2004, now abandoned.
(60) Provisional application No. 60/934,668, filed on Jun. 16, 2007.
(60) Provisional application No. 60/700,802, filed on Jul. 21, 2005.
(60) Provisional application No. 60/752,119, filed on Dec. 20, 2005.
(60) Provisional application No. 60/811,977, filed on Jun. 8, 2006.

(30) Foreign Application Priority Data
Jun. 21, 2011 (FR) 11 55467

(51) Int. Cl. G06Q 20/10

(52) U.S. Cl. CPC G06Q 20/102
USPC 705/40

(57) ABSTRACT

The invention provides for a readjustment between multiple account balances or accounts belonging to a payer, wherein the readjustment changes the funding source for a completed payment transaction from the payer's first balance or account to the payer's second balance or account, wherein the readjustment does not affect a payee of the completed payment transaction, and wherein the completed payment transaction comprises a completed electronic payment transaction, a completed check payment transaction, or completed a point of sale transaction.

### CROSS REFERENCE TO RELATED APPLICATIONS

This application is a continuation of U.S. application Ser. No. 12/665,003 and claims priority to each of: U.S. patent application Ser. No. 12/665,033 filed Dec. 16, 2009, which is pending and claims priority to PCT Application PCT/US08/67056 filed Jun. 15, 2008, which claims priority to U.S. Provisional Application 60/934,668 filed Jun. 17, 2007, each of which applications are entirely incorporated herein by reference. This application also claims priority to each of: U.S. patent application Ser. No. 13/956,520 filed Aug. 1, 2013, which is pending and claims priority to Ser. No. 13/779,646 filed Feb. 27, 2013, which is pending and claims priority to Ser. No. 13/525,750 filed Jun. 18, 2012, which is pending and claims priority to Ser. No. 11/612,467 filed Dec. 18, 2006, now issued as U.S. Pat. No. 8,332,293, which claims priority to Ser. No. 11/487,680 filed Jul. 17, 2006, which claims priority to U.S. Provisional Applications 60/700,602, filed Jul. 19, 2005, 60/752,119 filed Dec. 20, 2005, and 60/811,977 filed Jun. 8, 2006, wherein Ser. No. 11/487,680 filed Jul. 17, 2006 also claims priority to Ser. No. 10/865,188 filed Jun. 10, 2004, each of which applications are entirely incorporated herein by reference.

### FIELD OF THE INVENTION

The present invention provides check (draft) payment or electronic payment using alternative debiting and accounting functions from associated cash or credit balances that allow flexibility and control by the payer or account issuer for enabling crediting of check or electronic payments to additional cash or credit balances that further provide opportunities for the account provider or financial institution to have additional income from providing such methods and systems.

### BACKGROUND OF THE RELATED ART

Known check payment functions include remote capture that allows electronic check submission without having to deliver the physical check draft to a bank, as well as numerous other innovations. Electronic payments enable a payer to debit funds from a demand deposit account (DDA account), or other cash balances, and pay a bill electronically to a payee without needing to use a check draft. As known in the prior art, a payer is a person or entity that sends or originates a check draft or electronic payment, or is a party responsible for paying a bill. A payee is a person or entity to whom a check is made out, or is the recipient of a payer's electronic payment. A payee may comprise an individual, merchant, product or service provider, and the like.

Generally, financial accounts comprise either cash based or credit based accounts. Cash accounts can include a demand deposit account (DDA), a negotiable order of withdrawal (NOW) account, a checking account, a savings account, a money market account, a stored value account, and the like. Credit accounts can include a charge account, a revolving credit account, a line of credit, a home equity line of credit account (HELOC), a credit card account, and the like.

With regards to the movement and reconcilement of funds pertaining to check and electronic payments, such is typically performed in the United States of America using the Automated Clearing House (ACH), with an analogous system in Europe being the Pan-European Automated Clearing House (PE-ACH).

### SUMMARY OF THE PRESENT INVENTION

In the present invention payer accounts, account balances, etc., are intended as belonging to the payer. The terms “payer” and “customer” are herein interchangeable.

The term “cash balance” can include any kind of cash balance that can be used to facilitate check or electronic payments, such as but not limited to, a demand deposit account balance (DDA), a negotiable order of withdrawal (NOW) account balance, checking account balance, money market account balance, stored value account balance, and the like. The term “credit balance” can include, but is not limited to, any kind of credit balance that can be used to make check or electronic payments such as, but not limited to, a charge account balance, a revolving credit balance, a line of credit balance, home equity line of credit balance (HELOC), etc.

The present invention provides methods and systems for crediting of at least one portion of at least one check (draft) payment or electronic payment by debiting additional cash or credit balances using alternative debiting and accounting functions that allow flexibility and control by the payer or account issuer for enabling or facilitating check or electronic payments that further provide opportunities for the account provider or financial institution to have additional income by charging additional fees for providing such methods and systems.

The present invention provides a method, using a check or electronic payment account provided by an account provider for at least one payment of at least one check or electronic payment between a payer and payee, for providing at least one manual or automatic readjustment of said at least one payment, wherein (a) said readjustment comprises at least one transaction specific readjustment or at least one amount specific readjustment; (b) said readjustment does not affect said payee's receipt of said check or electronic payment; and (c) said at least one payment was paid by one selected from (i) debiting at least one first cash balance or (ii) initially debiting at least one first credit balance and then crediting said at least one first credit balance by debiting at least one second cash balance; said method comprising: A. identifying at least one posted check or electronic payment transaction comprising said transaction specific readjustment, or specifying at least one amount comprising said amount specific readjustment; B. readjusting at least a portion of the amount of said at least one posted check or electronic payment transaction, or said amount comprising said amount specific readjustment, by debiting said portion of the amount of said posted check or electronic payment, or debiting said amount comprising said amount specific readjustment, among at least one of said at least one first credit balance or at least one second credit balance; and C. crediting said portion of the amount of said posted check or electronic payment pertaining to said readjustment, or crediting said amount comprising said amount specific readjustment pertaining to said readjustment, among at least one of said first or second cash balance or second credit balance or at least one third cash or credit balance.

Such methods also provide a method, using a check or electronic-payment account provided by an account provider for payment of at least one check or electronic payment between a payer and payee, for providing at least one manual or automatic readjustment comprising at least one transaction specific readjustment or at least one amount specific readjustment, wherein said readjustment does not affect said payee's receipt of said check or electronic payment, comprising: (a) identifying at least one posted check or electronic payment transaction comprising said transaction specific readjustment, or specifying at least one amount comprising said amount specific readjustment, wherein cash balance funds corresponding to said posted check or electronic payment transaction, or cash balance funds corresponding to said amount comprising said amount specific readjustment, were frozen, and where said frozen funds are earmarked for the paid-together payment of said check or electronic payment; and (b) unfreezing at least a portion corresponding to the amount of said posted check or electronic payment transaction, or unfreezing said amount comprising said amount specific readjustment.

Such methods can include wherein said at least one portion is a percentage or amount of said at least one check or electronic payment amount, wherein said percentage is 0.001 to 100.000 percent or any value or range therein, and wherein said amount is $0.001 to at least $100,000 US dollars or any foreign equivalent thereof. Such methods can also include wherein said crediting or debiting is from a cash balance in a cash account or a credit balance in a credit account. Such methods can include wherein said cash account is a debit account or said credit account is a credit card account. Such methods can also include wherein said at least one of said cash and credit balances is selected from in-house or out-of-house credit or cash balances. Such methods can also include wherein said check or electronic payment account comprises a first credit balance and a first cash balance. Such a method's said readjustment is applied to said at least one check or electronic payment as a security feature that allows fraudulent check or electronic payments to be readjusted from said at least one cash balance with said at least one credit balance.

The present invention can also include a method for providing a check or electronic payment account by an account provider for at least one payment of at least one check or electronic payment between a payer and payee, comprising: (a) debiting at least one first credit balance for said payment of said check or electronic payment, where said debiting comprises the posting and paying of said payment, and said payment comprises a debit; and, (b) crediting said at least one first credit balance by debiting at least one second balance.

Such methods can include wherein said second balance is a cash or second credit balance. Such methods can also include wherein said debit is individually paid in-turn at a given time interval by said second balance. Such methods can further include wherein said debit comprises a plurality of debits that are automatically paid together at a given time interval by said second balance. Such methods can also include wherein said check or electronic payment account comprises a first credit balance and a first cash balance.

One or more given debiting of at least one portion of at least one posted check or electronic payment to additional cash or credit balances can include any combination or permutations of in-house, and/or out-of-house credit and/or cash balances. Furthermore, a given electronic payment may comprise where 1) a payer initiates a electronic payment by sending, or “pushing” a payment to a payee from the payer's payment account; or, 2) where a payee initiates a electronic payment by “pulling” a payment from a payer's payment account. A given electronic payment, as discussed within this disclosure and/or illustrated in the following examples, can be considered as being a “pushed” or “pulled” electronic payment. Also, there are no limiting aspects with regards to the following examples, therefore a given example can be deemed to illustrate “pushed” and/or “pulled” electronic payments, in any combination. Also, there is nothing that limits whether a given embodiment is a check payment embodiment, an electronic payment embodiment, or both, resulting where any given embodiment can be used for checks and/or electronic payments.

The different electronic steps above require use of computer-related components, such as computerized systems, computerized networks, computer processors, computer interfaces, computer-readable mediums, computer-related or electronic apparatus, wired or wireless networks or systems, etc., all of which are well known in their associated arts.

An exemplary system and network configuration of the present invention includes a multiple account provider comprising a multiple account transaction processor, one or more user interface systems, e.g., a web server, a voice response servicer; and/or a customer service terminal; one or more card processing networks; a credit servicer; charge servicer; debit servicer; and/or the like; and a card reader, which generally includes a POS device and/or a PIN device.

Information is processed by a transaction processor to ensure validity and support or the desired transaction account. If supported, then the transaction processor adds an association record to a lookup table. In an exemplary embodiment, the lookup table is a relational database such as Oracle, Sybase, IBM DB2, Microsoft SQL Server, etc., however, it may be any suitable storage system that resides in computer memory, magnetic disk storage, etc., and which optionally includes a database application service that is invoked by database access APIs which might comply with an established standard data access protocol such as SQL.

The present invention also provides in one aspect methods and systems for providing checks or electronic payments from two or more associated balances that can be employed to enable checks that include both credit and debit aspects. These “crebit” methods and systems comprise where the check or electronic payment does not directly debit at least one cash balance associated with the check or electronic payment account; rather, a credit balance associated with the account is debited, whereby the debit to the credit balance that is created by the check or electronic payment is subsequently credited by a debit to said cash balance(s).

Such “crebit” methods and systems can include where a given at least one portion of at least one posted check draft or electronic payment is debited from an initial credit balance, and within any time interval, such as instantaneously or immediately upon or after the debit to the initial credit balance occurs, or, two minutes, two hours, two days, etc., after the debit to the initial credit balance occurs, said debit is credited automatically, or “paid in-turn”, by a debit to at least one cash balance; or, a plurality of debits to the initial credit balance are automatically “paid together” at once at any given time interval, such as before, at, or after the end of a billing cycle.

The invention optionally includes a method for providing a readjustment between multiple account balances or accounts belonging to a payer for at least one completed payment transaction, the method comprising: A. electronically providing by a transaction processor the at least one completed payment transaction paid by the payer, Wherein the at least one completed payment transaction was paid using at least one first balance belonging to the payer, and wherein the at least one first balance was selected by the payer; B. electronically identifying using a transaction processor the at least one completed payment transaction; C. electronically debiting by a transaction processor at least one second balance belonging to the payer for at least one amount of the at least one completed payment transaction; and D. electronically crediting by a transaction processor the at least one amount to at least one different balance belonging to the payer, wherein the at least one different balance is different than the at least one second balance; wherein the readjustment provided in steps A through D: 1) changes the funding source for the at least one completed payment transaction from the at least one first balance belonging to the payer to the at least one second balance belonging to the payer, and 2) does not affect at least one payee of the at least one completed payment transaction; and wherein the at least one completed payment transaction remains paid by the payer using the at least one first balance when the readjustment is not applied to the at least one completed payment transaction.

The invention optionally includes a method for providing a readjustment between multiple account balances or accounts belonging to a payer for at least one completed payment transaction, the method comprising: A. electronically providing by a transaction processor the at least one completed payment transaction paid by the payer, wherein the at least one completed payment transaction was paid using at least one first balance belonging to the payer, and wherein the at least one first balance was selected by the payer; B. electronically specifying using a transaction processor at least one amount, wherein the at least one amount pertains to a full or partial portion of a total amount of the at least one completed transaction; C. electronically debiting by a transaction processor at least one second balance belonging to the payer for the at least one amount of the at least one completed payment transaction; and D. electronically crediting by a transaction processor at least one different balance belonging to the payer for the at least one amount, wherein the at least one different balance is different than the at least one second balance; wherein the readjustment provided in steps A through D: 1) changes the funding source for the at least one completed payment transaction from the at least one first balance belonging to the payer to the at least one second balance belonging to the payer, and 2) does not affect at least one payee of the at least one completed payment transaction; and wherein the at least one completed payment transaction remains paid by the payer using the at least one first balance when the readjustment is not applied to the at least one completed payment transaction.

The invention optionally includes at least one of: wherein the at least one completed payment transaction comprises at least one selected from the group consisting of: a completed electronic payment transaction, a completed check payment transaction, and a completed point of sale transaction; wherein the at least one different balance credited in step D comprises the at least one first balance; and wherein the at least one different balance credited in step D does not comprise the at least one first balance.

The invention optionally includes at least one of: wherein the readjustment is automatically triggered by a transaction processor to cover balance overdrafts or account overdrafts, thereby preventing non-sufficient funds conditions from occurring, and thereby preventing the rejection of at least one selected from the group consisting of: check payment transactions, electronic payment transactions, point of sale transactions, and ATM withdrawals; and wherein the readjustment is automatically triggered by a transaction processor to remedy at least one selected from the group consisting of: erroneous check payment transactions, fraudulent check payment transactions, erroneous electronic payment transaction amounts, fraudulent electronic payment transaction amounts, erroneous point of sale transactions, and fraudulent point of sale transactions.

The invention optionally includes at least one of: wherein the method enables an end user to electronically identify the at least one completed payment transaction in step B; and wherein the method enables an end user to electronically specify the at least one amount in step B.

The invention optionally includes at least one of: wherein the readjustment enables an end user to prevent non-sufficient funds conditions from occurring, thereby preventing the rejection of at least one selected from the group consisting of: check payment transactions, electronic payment transactions, point of sale transactions, and ATM withdrawals; and wherein a readjustment of an erroneous or fraudulent completed transaction is performed by an end user.

The invention optionally includes at least one of: wherein the at least one first balance belonging to the payer, the at least one second balance belonging to said payer, or the at least one different balance belonging to the payer comprises at least one selected from the group consisting of: at least one credit-based financial instrument and at least one cash-based financial instrument, wherein the at least one credit-based financial instrument comprises at least one selected from the group consisting of: a charge balance, a charge account, a revolving credit balance, a revolving credit account, a line of credit balance, a line of credit account, a charge card account, and a credit card account, wherein the at least one cash-based financial instrument comprises at least one selected from the group consisting of: a cash balance, a cash account, a demand deposit balance, a demand deposit account, a negotiable order of withdrawal balance, a negotiable order of withdrawal account, a checking balance, a checking account, a savings balance, a savings account, a money market balance, a money market account, a stored value balance, and a stored value account, and wherein the at least one first balance, the at least one second balance, or the at least one different balance comprises at least one selected from the group consisting of: an in-house balance, an in-house account, an out-of-house balance, and an out-of-house account.

The invention optionally includes at least one of: further comprising wherein only a portion of the at least one amount of the at least one completed payment transaction is electronically readjusted, wherein the portion is less than 100 percent of the at least one amount.

The invention optionally includes at least one of: wherein the at least one completed payment transaction comprising the at least one amount is identified; and wherein the at least one completed payment transaction comprising the at least one amount is not identified.

The invention optionally includes wherein a transaction processor comprises at least one computer.

### DESCRIPTION OF THE INVENTION

The present invention provides methods and systems for the debiting of at least one credit balance for at least one portion of at least one check (draft) payment or electronic payment, where said debiting is credited by debiting additional cash or credit balances using alternative debiting and accounting functions that allow flexibility and control by the payer or account issuer for enabling or facilitating check or electronic payments that further provide opportunities for the account provider or financial institution to have additional income by charging additional fees for providing such methods and systems.

The term “cash balance” can include any kind of cash balance that can be used to facilitate check or electronic payments, such as but not limited to, a demand deposit account balance (DDA), a negotiable order of withdrawal (NOW) account balance, checking account balance, money market account balance, stored value account balance, and the like. The term “credit balance” can include but is not limited to, any kind of credit balance that can be used to make check or electronic payments such as, but not limited to, a charge account balance, a revolving credit balance, a line of credit balance, home equity line of credit balance (HELOC), etc.

With regards to using one or more cash or credit balances according to the present invention, at least one balance can be maintained at the same financial institution as the check or electronic payment account, where such at least one balance is in-house. Alternatively, at least one associated, linked or related balance can be maintained at a different financial institution than the check or electronic payment account, where such at least one balance is out-of-house. Where two or more balances are used, such balances can be in-house, out-of-house, or any combination thereof. While the check or electronic payment account would be typically linked with at least one out-of-house balance in the United States of America using the Automated Clearing House (ACH), the present invention places no limitations whatsoever on the types of methods or systems that may be used to link the check or electronic payment account with at least one out-of-house balance.

In one aspect, the present invention provides a method or system for crediting at least one portion of at least one check or electronic payment posted to at least one first credit balance, comprising (a) debiting said at least one portion of said at least one posted check or electronic payment from at least one first cash balance or at least one second credit balance.

The invention can optionally include as an example, should an end user enter his financial card account number on the website for a given merchant, it is considered a point-of-sale transaction, even if the end user is making the purchase on a computer in the end user's house.

The invention can optionally include one or more of at least one of wherein (i) the total of the at least two account balances is greater than or equal to the debit amount; (ii) at least one selected account balance, as determined by the transaction processor, is greater than or equal to the assigned portion of the debit amount corresponding to the at least one selected account balance; or (iii) at least one selected account balance, as determined by the transaction processor, is able to compensate for a deficiency in at least one other selected account balance that is less than the assigned portion of the debit amount corresponding to the at least one selected account balance using Rescue or Reject criteria, where the assigned portion is determined by the transaction processor; and wherein the transaction amount is debited from or credited to the at least one account balances by at least one selected from (i) according to the assigned portion determined by the transaction processor, (ii) according to at least one Best Fit criteria; (iii) according to the assigned portion; and (iv) according to Rescue or Reject criteria.

These and other aspects of the present invention are further described, but not limited by, the following examples, which are only illustrative of specific examples of the present invention.

### Examples

In the examples to follow, check or electronic payment is exemplified. While the following examples will attempt to be illustrative, they are non-limiting to the scope of the present invention.

This first example shows a common, everyday, check or electronic payment, whereby each check or electronic payment debits a payer's cash balance:

| | | | Amt Debited |
|---|---|---|---|
| Date | Description | Amount | Frm Cash Bal |
| 01-02 | Check/Payment | 40.00 | 40.00 |
| 01-09 | Check/Payment | 20.00 | 20.00 |
| 01-15 | Check/Payment | 60.00 | 60.00 |
| 01-20 | Check/Payment | 40.00 | 40.00 |
| 01-23 | Check/Payment | 20.00 | 20.00 |
| 01-28 | Check/Payment | 80.00 | 80.00 |
| | TOTAL | 260.00 | 260.00 |

Less traditionally per current methods, user-adjustable check or electronic payment parameters can enable the automatic debiting of two or more cash balance funding sources. In the following example using an amount threshold parameter, checks/payments up to $40 debit cash balance #1, whereby checks/payments above $40 debit cash balance #2.

| | | | Cash Bal | Cash Bal |
|---|---|---|---|---|
| Date | Description | Amount | #1 Debit | #2 Debit |
| 01-02 | Check/Payment | 40.00 | 40.00 | 0 |
| 01-09 | Check/Payment | 20.00 | 20.00 | 0 |
| 01-15 | Check/Payment | 60.00 | 0 | 60.00 |
| 01-20 | Check/Payment | 40.00 | 40.00 | 0 |
| 01-23 | Check/Payment | 20.00 | 20.00 | 0 |
| 01-28 | Check/Payment | 80.00 | 0 | 80.00 |
| | TOTAL | 260.00 | 120.00 | 140.00 |

In addition to the amount threshold parameter, other parameters include, e.g., remainder threshold (“debit the first $20 of the check/payment from cash balance #1 and debit any remainder amount above $20 from cash balance #2”); ratio (“debit 50% of the check/payment from cash balance #1 and debit the remaining 50% from cash balance #2”); account balance information (“debit checks/payments up to $20 from cash balance #1 and debit checks/payments over $20 from cash balance #2; however, if cash balance #1 falls below $100, then only debit account balance #2 for all checks/payments”) and, account balance consumption (“if consumption relating to check or electronic payments exceeds $100 for the day, then debit cash balance #2, otherwise, debit cash balance #1”, or, “if consumption relating to check or electronic payments exceeds $1000 for the month, then debit cash balance #2, otherwise, debit cash balance #1”).

Check or Electronic Payments—“Paid in-Turn” Embodiments

This next example shows where check or electronic payments are made, but an initial credit balance is debited by the check or electronic payment amount, and within any time interval, such as instantaneously or immediately upon or after the debit to the initial credit balance occurs, or, two minutes, two hours, two days, etc., after the debit to the initial credit balance occurs, said debit is “paid in-turn” and credited automatically by a debit to the cash balance, whereby the initial credit balance is zeroed-out (paid in full).

| | | | Credit Bal | Amt Debited | Net Effect |
|---|---|---|---|---|---|
| Date | Description | Amount | Debit | Frm Cash Bal | Credit Bal |
| 01-02 | Check/Payment | 40.00 | 40.00 | 40.00 | 0 |
| 01-09 | Check/Payment | 20.00 | 20.00 | 20.00 | 0 |
| 01-15 | Check/Payment | 60.00 | 60.00 | 60.00 | 0 |
| 01-20 | Check/Payment | 40.00 | 40.00 | 40.00 | 0 |
| 01-23 | Check/Payment | 20.00 | 20.00 | 20.00 | 0 |
| 01-28 | Check/Payment | 80.00 | 80.00 | 80.00 | 0 |
| | TOTAL | 260.00 | 260.00 | 260.00 | 0 |

Here, the debit to the initial credit balance caused by a check or electronic payment is in many cases (with exceptions to be discussed) a temporary situation that exists only until the debit is automatically paid by at least one cash balance. Being that there is no real “loan” in many cases due to the impending payment by at least one cash balance, it is possible that certain, if not all, fees and interest normally associated with using a credit balance would be minimized or waived altogether, or never levied in the first place, with certain fees and/or interest being applicable to any credit balance items that remain open for any particular length of time, where said fees and/or interest are typical of credit balance usage in general.

In traditional check payment or electronic payment systems, a given check or payment coincidentally provides the payee with access information about the payer's cash balance used to pay said payment. Such access information can ultimately jeopardize the payer's cash balance by placing it directly in the “line of fire” for fraudulent abuse purposes. What is viewed as especially salient is that by first debiting a credit balance for a check payment or electronic payment, the credit balance acts as a “credit firewall” for any cash balances associated with a given the check payment or electronic payment embodiments. In certain credit-based financial instruments, such as credit card accounts, account providers have federally mandated metrics that provide remedies such as limited liability for fraudulent activity. Such analogous metrics can be applied to check or payments that post to, or debit, a credit balance instead of a cash balance. Such comprises a feature that can offer an advantage for a given account provider, and can also result in avenues for fee revenue generation from customers that wish to avail themselves to such features.

The following example is a “paid in-turn” check or electronic payment embodiment using two cash balances, although any number of cash balances (or even credit balances) may be used. Here, using an amount threshold parameter, checks/payments up to $40 debit cash balance #1, whereby checks/payments above $40 debit cash balance #2.

| | | | Credit Bal | Amt Debited | Amt Debited |
|---|---|---|---|---|---|
| Date | Description | Amount | Debit | Cash Bal #1 | Cash Bal #2 |
| 01-02 | Check/Payment | 40.00 | 40.00 | 40.00 | 0 |
| 01-09 | Check/Payment | 20.00 | 20.00 | 20.00 | 0 |
| 01-15 | Check/Payment | 60.00 | 60.00 | 0 | 60.00 |
| 01-20 | Check/Payment | 40.00 | 40.00 | 40.00 | 0 |
| 01-23 | Check/Payment | 20.00 | 20.00 | 20.00 | 0 |
| 01-28 | Check/Payment | 80.00 | 80.00 | 0 | 80.00 |
| | TOTAL | 260.00 | 260.00 | 120.00 | 140.00 |

As disclosed in the earlier check or electronic payment section regarding two or more cash balance funding sources, in addition to the amount threshold parameter, other parameters adapted to check or electronic payments comprise: remainder threshold (“debit the first $20 of the check/payment amount from cash balance #1, and debit any remainder amount above $20 from cash balance #2”); ratio (“debit ⅓ (one third) of the check/payment amount from cash balance #1, and debit ⅔ (two thirds) of the check/payment amount from cash balance #2”); account balance information (“debit checks/payments up to $20 from cash balance #1 and debit checks/payments over $20 from cash balance #2; however, if cash balance #1 falls below $100, then only debit account balance #2 for all checks/payments”), and account balance consumption (“if consumption relating to check or electronic payments exceeds $100 for the day, then debit cash balance #2, otherwise, debit cash balance #1”, or (“if consumption relating to check or electronic payments exceeds $1000 for the month, then debit cash balance #2, otherwise, debit cash balance #1”).

An important point needs to be made here. As mentioned in the above example, and carrying through to the following examples as well, at least one credit balance may be used as a funding source, in addition to, or in place of, at least one cash balance. As mentioned earlier, a credit balance may comprise any kind of credit balance, comprising a charge account balance, a revolving credit balance, a line of credit balance, home equity line of credit balance (HELOC), etc.

Furthermore, with check or electronic payment parameters that enable a given check or electronic payment to draw from two or more funding sources simultaneously, said funding sources may comprise any combination or permutation of in-house or out-of-house cash balances and/or in-house or out-of-house credit balances. Finally, in such embodiments that employ more than one credit balance, where said more than one credit balance comprises either at least one initial credit balance that is debited for the check or electronic payment amount, and/or at least one funding source credit balance, it is disclosed that any or all credit balances comprising a given embodiment may comprise identical or different kinds of credit balances.

Two or more payment sources can “back up” each other; so, in the above example if cash balance #1 was depleted, then cash balance #2 can take over using “Best Fit” (debit at least one payment source that can “best fit”, or best accommodate, the check or electronic payment) and/or “Rescue or Reject” (either “rescue” the check or electronic payment by using at least one other non-depleted balance as a partial/full payment source in place of, or in addition to, the balance(s) depleted before or during the check or electronic payment, or “reject” the check or electronic payment). As that any combination of in-house or out-of-house cash and/or credit balances may be used as payment sources, the use of any combination of in-house or out-of-house cash and/or credit balances applies with regards to “Best Fit” and/or “Rescue or Reject” criteria as well.

Check or Electronic Payment—“Paid in-Turn”—Depleted Cash Balance

In the next example, check or electronic payments are allowed even when the cash balance is depleted.

| | | | Credit Bal | Amt Debited | Net Debit |
|---|---|---|---|---|---|
| Date | Description | Amount | Debit | Frm Cash Bal | Credit Bal |
| 01-02 | Check/Payment | 40.00 | 40.00 | 40.00 | 0 |
| 01-09 | Check/Payment | 20.00 | 20.00 | 20.00 | 0 |
| 01-15 | Check/Payment | 60.00 | 60.00 | 60.00 | 0 |
| 01-20 | Check/Payment | 40.00 | 40.00 | 40.00 | 0 |

AVAILABLE CASH BALANCE DEPLETED - SUBSEQUENT CHECK
OR ELECTRONIC BILL PAYMENTS WILL BE TREATED
AS “OPEN” CREDIT BALANCE ITEMS.

| | | | | | |
|---|---|---|---|---|---|
| 01-23 | Check/Payment | 20.00 | 20.00 | 0 | 20.00 |
| 01-28 | Check/Payment | 80.00 | 80.00 | 0 | 80.00 |
| | TOTAL | 260.00 | 260.00 | 160.00 | 100.00 |

After the 01-20 check or electronic payment, the cash balance that ordinarily credited the check or electronic payment debits to the initial credit balance was depleted; however, check or electronic payments were still possible on 01-23 and 01-28 being that they comprise “open” credit balance items, which most likely will entail a levy of accrued interest and/or fees, whereby the debits to the initial credit balance that comprise the open items will be paid back by the payer at a future time. It is very important to note that automatically enabling check or electronic payments in excess of any cash balances (thereby resulting in open items on the initial credit balance, or resulting in accessing a line of credit as an overdraft safeguard, or even resulting in an overdraft, depending on the given check or electronic payment embodiment and/or circumstances) is an optional and additional aspect of the method. It is entirely possible for an account provider to allow or not allow such open credit balance items; furthermore, a payer could have the preset option of allowing open credit balance items, or to not allow open credit balance items in excess of available cash on hand in the payer's account. In such instances where open credit balance items are not automatically permitted, or are otherwise not desired, any check or electronic payment presentation that exceeds the cash balance(s) can be rejected, and/or a notification regarding the check or electronic payment can inform the payer of the deficient cash balances(s) condition, and ask the payer whether an open credit balance item is desired in place of a check or electronic payment debit from the payer's cash balance(s). Nonetheless, enabling, or even encouraging, open credit balance items is viewed as a useful and salient aspect pertinent to any applicable embodiment or example comprising the present disclosure.

### Check or Electronic Payments—“Paid Together” Embodiments

In the following example, check or electronic payments debit the initial credit balance; however, instead of automatically paying the individual debits to the initial credit balance “in-turn” with at least one cash balance, the at least one cash balance is cumulatively frozen, suspended, earmarked, or otherwise allocated for the amounts of the check or electronic payments, and the checks/payments are “paid together” at a given time, such as on a specific date, after a given time interval, such as every two weeks, or before, at, or after the close of a billing cycle, using the cumulatively frozen cash balance.

| | | | Credit Bal | Cash Bal | Net Effect |
|---|---|---|---|---|---|
| Date | Description | Amount | Debit | Frozen | Credit Bal |
| 01-02 | Check/Payment | 40.00 | 40.00 | 40.00 | 40.00 |
| 01-09 | Check/Payment | 20.00 | 20.00 | 60.00 | 60.00 |
| 01-15 | Check/Payment | 60.00 | 60.00 | 120.00 | 120.00 |
| 01-20 | Check/Payment | 40.00 | 40.00 | 160.00 | 160.00 |
| 01-23 | Check/Payment | 20.00 | 20.00 | 180.00 | 180.00 |
| 01-28 | Check/Payment | 80.00 | 80.00 | 260.00 | 260.00 |

01-31 FROZEN CASH BALANCE IS DEBITED TO CREDIT
CHECK OR ELECTRONIC BILL PAYMENT DEBIT AMOUNTS

| | | | | |
|---|---|---|---|---|
| TOTAL | 260.00 | 0 | 0 | 0 |

On 01-31, the cumulatively frozen cash amount of $260 was transferred (debited) to credit the debits to the initial credit balance caused by the check or electronic payments. While either the payer and/or the account provider can perform such transfers manually, it is reasonable that automated transfers would be preferable, if not typical, in most instances.

As disclosed earlier regarding “paid in-turn” check or electronic payment embodiments, any “paid together” check or electronic payment embodiments can comprise at least one cash balance funding source and/or at least one credit balance funding source. As with the “paid in-turn” check or electronic payment embodiments, any “paid together” check or electronic payment embodiments can comprise any check or electronic payment parameters to determine which one or more than one of the at least one funding source will be used, such parameters comprising amount threshold, remainder threshold, ratio, etc.; and, account balance information. Prepayment is also a possibility, where at least one check or electronic payment is manually or automatically paid prior to the time when the check or electronic payments are paid together (where, per the above example, prepayment would occur prior to the 01-31 crediting of the check debit amounts). Such prepayments can occur using an online entry, customer service representative, etc. Furthermore, such prepayment can be subsequently readjusted and paid again. In fact, this disclosure places no theoretical limits on the amount of times a given check or electronic payment can be prepaid, readjusted, then paid prior to the transactions being “paid together”. Even after the transactions are paid together, it is within the scope of this disclosure to enable at least one subsequent readjustment of the “paid together” transactions.

### Check or Electronic Payments—“Paid Together”—Depleted Cash Balance

This example shows a “paid together” embodiment whereby the cash balance available for freezing becomes depleted. As a result of the depletion condition, no additional cash balance funds can be allocated to pay for the debits to the initial credit balance that result due to the check or electronic payments.

| | | | Credit Bal | Cash Bal | Net Effect |
|---|---|---|---|---|---|
| Date | Description | Amount | Debit | Frozen | Credit Bal |
| 01-02 | Check/Payment | 40.00 | 40.00 | 40.00 | 40.00 |
| 01-09 | Check/Payment | 20.00 | 20.00 | 60.00 | 60.00 |
| 01-15 | Check/Payment | 60.00 | 60.00 | 120.00 | 120.00 |
| 01-20 | Check/Payment | 40.00 | 40.00 | 160.00 | 160.00 |

ZERO CASH RESERVES REMAIN FOR FREEZING -
SUBSEQUENT CHECK OR ELECTRONIC BILL PAYMENTS
WILL BE TREATED AS “OPEN” CREDIT BALANCE ITEMS.

| | | | | | |
|---|---|---|---|---|---|
| 01-23 | Check/Payment | 20.00 | 20.00 | 160.00 | 180.00 |
| 01-28 | Check/Payment | 80.00 | 80.00 | 160.00 | 260.00 |

01-31 FROZEN CASH BALANCE IS DEBITED TO
PARTIALLY CREDIT CHECK OR ELECTRONIC BILL
PAYMENT DEBIT AMOUNTS

| | | | | |
|---|---|---|---|---|
| TOTAL | 260.00 | 0 | 0 | 100.00 |

After the 01-20 check or electronic payment, the cash balance that sourced the frozen cash balance was depleted; however, check or electronic payments were still possible on 01-23 and 01-28 being that they comprise open credit balance items. As analogous with the earlier “paid in-turn” embodiment, kindly note that automatically enabling check or electronic payments in excess of the capability to allocate frozen cash balance amounts (thereby resulting in open items on the initial credit balance, or resulting in accessing a line of credit as an overdraft safeguard, or even resulting in an overdraft, depending on the given check or electronic payment embodiment and/or circumstances) is an optional aspect of the method. It is entirely possible for an offering entity to allow or not allow such open credit balance items; furthermore, a payer could have the preset option of allowing open credit balance items or to not allow open credit balance items in excess of the capability to allocate frozen cash balance amounts in the payers account. In such instances where open credit balance items are not automatically permitted, or are otherwise not desired, any check or electronic payment request that exceeds the capability to allocate frozen cash balance amounts can be rejected, and/or a notification regarding the check or electronic payment can inform the payer of the deficiency regarding the cash balance(s) condition, and ask the payer whether an open credit balance item is desired.

### Check or Electronic Payments—Combination “Paid in Turn” and “Paid Together” Embodiments

This check or electronic payment example is a combines “paid in-turn” and “paid together” aspects using two cash balances. Using an amount threshold parameter, checks/payments up to $40 debit cash balance #1, where the checks/payments are “paid in-turn”, whereby checks/payments above $40 debit cash balance #2, where the amounts are frozen, and “paid together” at the end of the month.

| | | | Credit Bal | Amt Debited | Amt Frozen |
|---|---|---|---|---|---|
| Date | Description | Amount | Debit | Cash Bal #1 | Cash Bal #2 |
| 01-02 | Check/Payment | 40.00 | 40.00 | 40.00 | 0 |
| 01-09 | Check/Payment | 20.00 | 20.00 | 20.00 | 0 |
| 01-15 | Check/Payment | 60.00 | 60.00 | 0 | 60.00 |
| 01-20 | Check/Payment | 40.00 | 40.00 | 40.00 | 0 |
| 01-23 | Check/Payment | 20.00 | 20.00 | 20.00 | 0 |
| 01-28 | Check/Payment | 80.00 | 80.00 | 0 | 140.00 |

01-31 FROZEN FUNDS FROM CASH BALANCE #2 ARE DEBITED
TO CREDIT ALL CHECK OR ELECTRONIC BILL PAYMENT
DEBIT AMOUNTS ABOVE $40

| | | | | |
|---|---|---|---|---|
| TOTAL | 260.00 | 260.00 | 120.00 | PAID |

### Check or Electronic Payments Using Two or More Initial Credit Balances

The following “paid in-turn” example shows where check or electronic payments can debit at least two initial credit balances. Using an amount threshold parameter, check/payment amounts up to $40 debit initial credit balance #1, where check/payment amounts above $40 debit initial credit balance #2. There could be any reason for using at least two initial credit balances, such as where one balance is in-house where the other is out-of-house, different billing cycles, withdrawal minimum or maximums for a given credit balance, (such as a daily maximum), etc.

| | | | Ini Credit | Ini Credit | Amt Debited |
|---|---|---|---|---|---|
| Date | Description | Amount | #1 Debit | #2 Debit | Cash Bal |
| 01-02 | Check/Payment | 40.00 | 40.00 | 0 | 40.00 |
| 01-09 | Check/Payment | 20.00 | 20.00 | 0 | 20.00 |
| 01-15 | Check/Payment | 60.00 | 0 | 60.00 | 60.00 |
| 01-20 | Check/Payment | 40.00 | 40.00 | 0 | 40.00 |
| 01-23 | Check/Payment | 20.00 | 20.00 | 0 | 20.00 |
| 01-28 | Check/Payment | 80.00 | 0 | 80.00 | 80.00 |
| | TOTAL | 260.00 | 120.00 | 140.00 | 260.00 |

In addition to the amount threshold parameter, other earlier disclosed parameters can be adapted to initial credit balance debiting as well, such as remainder threshold (“debit the first $20 of the check or electronic payment from initial credit balance #1 and debit any remainder amount above $20 from initial credit balance #2”); ratio (“debit 50% of the check or electronic payment from initial credit balance #1 and debit the remaining 50% from initial credit balance #2”); account balance information (“debit check or electronic payments up to $20 from initial credit balance #1 and debit check or electronic payments over $20 from initial credit balance #2; however, if initial credit balance #1 falls below $1000, then only debit initial credit balance #2 for all check or electronic payments”) and, account balance consumption (“if consumption of initial credit balance #1 exceeds $100 for the day, then debit initial credit balance #2, otherwise, debit initial credit balance #1”, or, “if consumption of initial credit balance #1 exceeds $1000 for the month, then debit initial credit balance #2, otherwise, debit initial credit balance #1”).

### Check or Electronic Payment—Determining Whether to Pay or Leave Unpaid as an Open Credit Balance Item

Check or electronic payment parameters can also enable which checks/payments are to be left unpaid as an open credit balance item that is to be paid at a future time. In this “paid in-turn” example using amount threshold parameters, check/payment amounts up to $20 are paid using balance #1 (Bal #1), which is an cash balance; check/payment amounts above $20 up to $40 are paid using balance #2 (Bal #2), which is a credit balance, such as a home equity line of credit (HELOC), and check/payment amounts above $40 are left unpaid as open credit balance items which the payer will pay at a future date.

| | | | Ini | | | |
|---|---|---|---|---|---|---|
| | | | Credit | Amt | Amt | Cash |
| | | | Bal | Debited | Debited | Ad- |
| Date | Description | Amount | Debit | Bal #1 | Bal #2 | vance |
| 01-02 | Check/Payment | 40.00 | 40.00 | 0 | 40.00 | 0 |
| 01-09 | Check/Payment | 20.00 | 20.00 | 20.00 | 0 | 0 |
| 01-15 | Check/Payment | 60.00 | 60.00 | 0 | 0 | 60.00 |
| 01-20 | Check/Payment | 40.00 | 40.00 | 0 | 40.00 | 0 |
| 01-23 | Check/Payment | 20.00 | 20.00 | 20.00 | 0 | 0 |
| 01-28 | Check/Payment | 80.00 | 80.00 | 0 | 0 | 80.00 |
| | TOTAL | 260.00 | 260.00 | 40.00 | 120.00 | 140.00 |

While the amount threshold parameter enables higher value check/payment amounts to remain as open credit balance items, the opposite (enabling lower value check/payment amounts to remain as open credit balance items) are also possible. While the practicality of the above can possibly be called into question in terms of fees and/or interest, the above example basically illustrates the possibilities. In addition to the amount threshold parameter illustrated, any check or electronic payment parameters, such as: remainder threshold (“for check/payment amounts up to $20, debit the cash balance to credit the debit to the credit balance created by the check or electronic payment, and leave any remainder amount above $20 as an open credit balance item”); ratio (debit the cash balance to credit the debit to the credit balance for ¾ (three quarters) of the check or electronic payment amount, and leave the remaining ¼ (one quarter) of the check or electronic payment amount as an open credit balance item”; and, account balance information (“if the cash balance falls below $100, allow the check or electronic payment to remain as an open item on the credit balance”) may be used. Furthermore, and very importantly, the above example demonstrates where cash balances (Bal #1) and credit balances (Bal #2) are used as payment sources for checks/payments.

### Readjustment

Readjustments will be exemplified throughout the remainder of the disclosure. A given check or electronic payment that has already been paid can be partially or fully readjusted by debiting at least one credit balance, and crediting at least one cash balance (and/or crediting at least one second credit balance) for the amount of the check or electronic payment. A readjustment can be deployed manually by a payer, with the payer using any kind of interface, such as an online account entry via the Internet, phone menu selection, assistance from a customer service representative, etc. that enables the end user to perform a readjustment. Readjustments may also occur automatically, where a paid check/payment is automatically readjusted, for any reason, such as where the resultant cash can be used to prevent overdrafts from occurring (such as preventing a non-sufficient funds condition from occurring, thereby preventing another transaction from rejecting), to facilitate a cash withdrawal from an ATM, and the like. Also, an automatic readjustment on erroneous or fraudulent activity may occur to help mitigate hardships related to fraudulent activity that will be discussed later. Regardless of whether a readjustment comprises a manual or automatic readjustment, the end result is basically at least one open credit balance item.

Such readjustments can comprise transaction specific readjustments, and amount specific readjustments. A transaction specific readjustment is where a payer highlights, or otherwise identifies, one or more specific paid check or electronic payment transactions that he wishes to readjust where highlighting or otherwise identifying any check or electronic payment for readjustment can occur using any suitable method, such as where at least one given item is displayed on an online account interface and is “clicked on”, or whether a desired check or payment is identified using a telephone system that enables selection, conveying a selection to a customer service representative via telephone, via fax, etc. An amount specific readjustment is where a payer enters a desired amount for readjustment, resulting where specific paid check or electronic payment transactions are fully or partially readjusted using any desired selection criteria (typically established by the account provider, with an optional possibility of offering selection choices to the payer/account owner) such as FIFO (first in, first out), LIFO (last in, first out), lowest value transaction first, highest transaction value first, partial amounts of several transactions, etc. Furthermore, it is possible to readjust an amount where specific transactions are not identified per say, but where an amount results in a debit to at least one credit balance and a credit to at least one cash balance, so if an account used for check or electronic payment shows that there is, say, $500 in paid check or electronic payments available for readjustment, then the full or partial $500 amount can be subsequently readjusted, either with or without involving or specifically identifying specific check or electronic payment transactions for readjustment purposes, where said full or partial $500 amount becomes an open credit balance item, and at least one cash balance is credited with said full or partial $500 amount. Such amount specific readjustments that have only paid amounts readjusted, and not specific transactions readjusted, would not necessarily need to comprise the readjustment of specific transactions, just the readjustment of amounts related to the paid transactions; nonetheless, as seen above, this disclosure does allows for an amount specific readjustment to comprise the full or partial readjustment of specific transactions in order to arrive at the desired readjustment amount.

An extremely crucial aspect here is that a readjustment is intended to not affect the payee whatsoever. Very simply, even though a given check or payment is readjusted at the level of the payer's account, the actual check or payment, as received by the payee, is unaffected. In fact, a given readjustment of a check or payment can even occur after a check draft or payment has cleared, after the payee has been paid in full, where the subsequent readjustment has absolutely no effect whatsoever on the “paid” status of the payee. Basically, a check or electronic payment that has been paid using a cash balance (either where at least one cash balance was originally debited for a given check or electronic payment, or where at least one credit balance was originally debited for a given check or electronic payment resulting in an open credit balance item, and at least one cash balance was debited to pay said open credit balance item), and that is subsequently readjusted converts to an open credit balance item that the end user is expected to pay at a later time, with an exception being where an erroneous or fraudulent charge or payment can be readjusted, enabling the erroneous or fraudulent open credit balance item to be attended to on behalf of the payer. In addition to the conversion to an open credit balance item, the cash resulting from the readjustment is credited to at least one cash balance. Outside of an erroneous or fraudulent charge or payment, all of this readjustment activity occurring at the payer's account level is intended as having no effect on the payee's receipt of the check or electronic payment.

Also, a question may arise as to how long can a readjustment be performed after a paid check or electronic payment is posted. This is a question best left to an account provider in that certain account providers may only want to enable readjustments up to a given period, such as up to the end of a given billing cycle, while other account providers could allow for any paid check or electronic payment to be readjusted months later, years later, etc., for any reason whatsoever. The basic answer is that this disclosure places no limitations or restrictions whatsoever on how long a readjustment can be performed after a paid check or electronic payment is posted, whereby such a decision is best left to a given account provider.

As with many things in the field of payments where end-user notification is prudent, any notification means such as E-mail can notify the payer that an automatic readjustment occurred, which could also act as an alert the payer as to potential error or fraud. In fact, such notification is also useful in the instance of a “manual” readjustment performed by or on behalf of the payer that acts as a confirmation.

“Paid in-Turn” Readjustment

Keeping in mind where the debit to the initial credit balance caused by the check or electronic payment is “paid in-turn” by at least one cash balance, the initial credit balance that is paid by at least one cash balance can be either manually or automatically readjusted, where at least one cash balance is credited for the readjusted amount, and where the readjusted amounts are rendered as open credit balance items that are paid back at a future time. A readjustment is useful for many purposes, such as a higher need for the cash, to cover other check or electronic payment overdrafts, to pay account related fees, etc.

| | | | Credit Bal | Amt Debited | Net Effect |
|---|---|---|---|---|---|
| Date | Description | Amount | Debit | Frm Cash Bal | Credit Bal |
| 01-02 | Check/Payment | 40.00 | 40.00 | 40.00 | 0 |
| 01-09 | Check/Payment | 20.00 | 20.00 | 20.00 | 0 |
| 01-15 | Check/Payment | 60.00 | 60.00 | 60.00 | 0 |
| 01-20 | Check/Payment | 40.00 | 40.00 | 40.00 | 0 |
| 01-21 | 01-15 Amount | | | (60.00) | 60.00 |
| | Readjusted | | | | |
| 01-21 | 01-20 Amount | | | (40.00) | 40.00 |
| | Readjusted | | | | |
| 01-23 | Check/Payment | 20.00 | 20.00 | 20.00 | 0 |
| 01-28 | Check/Payment | 80.00 | 80.00 | 80.00 | 0 |
| | TOTAL | 260.00 | 260.00 | 160.00 | 100.00 |

On 01-21, the payer performed a readjustment by highlighting, or otherwise identifying, the 01-15 and 01-20 check or electronic payments, thereby debiting the initial credit balance for a total of $100, and crediting the cash balance for a total of $100. The payer will pay the debits to the initial credit balance at a future time. In embodiments comprising more than one cash balance source, it is herein disclosed that a credit to at least one cash balance as a result of a readjustment can be either to the cash balance originally used to pay the initial credit balance for the check/payment item, and/or to at least one additional cash balance. While all check or electronic payment credit balance activity in the above example involves only the initial credit balance, it is very important to note that a readjustment can debit the at least one credit balance comprising the initial credit balance(s) used to pay for the check/payment item; or, a readjustment can debit at least one other credit balance in place of, or in addition to, any initial credit balance(s) normally debited for check or electronic payments.

Traditional Cash Balance-Based Check or Electronic Payment Modified with Readjustment Capability

It is very important to note that readjustments per the above example are readily adaptable to traditional check or electronic payment embodiments where the check or electronic payment debits an initial cash balance (as opposed to a credit balance as illustrated in typical examples contained herein). A paid check or electronic payment paid by debiting an initial cash balance can be readjusted by debiting at least one associated credit balance, thereby crediting or restoring said initial cash balance originally debited by the check or electronic payment, and/or crediting at least one other cash balance. Also, a given traditional check or electronic payment embodiment that debits a cash balance for payment can be enhanced or modified by associating at least one credit balance for the purpose of enabling the readjustment function. Such said credit balance may also serve an overdraft function typical in some cash balance account embodiments; however, it must be made clear that traditional overdraft credit lines do not serve in a readjustment capacity as disclosed herein.

The following example shows a typical check and/or electronic payment embodiment where checks/electronic payments debit a cash balance. Additional is an associated credit balance used to facilitate readjustments.

| | | | Cash | Readjustment | Net |
|---|---|---|---|---|---|
| | | | Bal | Amount | Effect |
| Date | Description | Amount | Debit | Unpaid | Credit Bal |
| 01-02 | Check/Payment | 40.00 | 40.00 | 0 | 0 |
| 01-09 | Check/Payment | 20.00 | 20.00 | 0 | 0 |
| 01-15 | Check/Payment | 60.00 | 60.00 | 0 | 0 |
| 01-20 | Check/Payment | 40.00 | 40.00 | 0 | 0 |
| 01-21 | 01-15 Amount | | | (60.00) | 60.00 |
| | Readjusted | | | | |
| 01-21 | 01-20 Amount | | | (40.00) | 40.00 |
| | Readjusted | | | | |
| 01-23 | Check/Payment | 20.00 | 20.00 | 0 | 0 |
| 01-28 | Check/Payment | 80.00 | 80.00 | 0 | 0 |
| | TOTAL | 260.00 | 260.00 | 100.00 | 100.00 |

Throughout the activity illustrated above, all check or electronic payments debited a cash balance. On 01-21, the payer performed a readjustment on the 01-15 and 01-20 check or electronic payments, thereby debiting the associated credit balance for a total of $100, and crediting the cash balance that was originally used to debit check/payment amounts for a total of $100. Kindly note that it is possible for the cash resulting from the readjustment to credit at least one desired cash balance, which may or may not comprise the cash balance that was originally used to pay the check/payment amounts. An associated credit balance as referenced above may comprise one or more credit balances of any kind. While such an enhancement comprising associating at least one credit balance to enable readjustment functionality to a preexisting check/electronic payment embodiment is possible, it is also envisioned that self-contained embodiments comprising cash balance payment functionality with credit balance-related readjustment capability already built-in are possible.

“Paid Together” Readjustment—Using Funds from the Frozen Cash Balance

In a “paid together” check/electronic payment, the actual check/electronic payments are yet to be paid by any cumulatively frozen, suspended, earmarked, or otherwise allocated funds, so a readjustment basically comprises a withdrawal, or “unfreezing”, of the frozen funds. Such can comprise a transaction-specific readjustment, where at least one specific transaction is highlighted or otherwise identified, and the frozen/earmarked funds directly corresponding to the at least one specific transaction is withdrawn, whereby the at least one specific transaction is carried forward as an open item; or an amount-specific readjustment, where an amount is specified, and using any desired method as mentioned earlier such as FIFO, LIFO, etc. the frozen/earmarked funds directly corresponding to the at least one specific transaction is automatically identified, unfrozen, and withdrawn, whereby the at least one specific transaction is carried forward as an open item; or an amount-specific readjustment where specific corresponding transactions are not identified per say, but an amount of frozen/earmarked funds are unfrozen and deducted leaving a unallocated or uncovered amount on at least one credit balance that needs to be restored.

Regardless of whether a transaction specific or amount specific readjustment, unfrozen and deducted funds may possibly result in a shortfall of “paid together” payment funds. It is important to realize that while unfrozen funds may be withdrawn, unfrozen funds do not have to be withdrawn per se. The unfrozen funds may reside in the cash balance that they were frozen in, and/or may reside in at least one other cash balance. Also note that all of these amount/transaction selection methods are analogous to those described in the prior “paid in-turn” section on readjustments, but differ from those readjustment methods due to the fact that the earlier disclosed readjustment deals with transactions that have already been paid, and not the abovementioned transactions that are earmarked to be paid later).

The following example shows a “paid together” embodiment, where an amount corresponding to a transaction is withdrawn.

| | | | Credit Bal | Cash Bal | Net Effect |
|---|---|---|---|---|---|
| Date | Description | Amount | Debit | Frozen | Credit Bal |
| 01-02 | Check/Payment | 40.00 | 40.00 | 40.00 | 40.00 |
| 01-09 | Check/Payment | 20.00 | 20.00 | 60.00 | 60.00 |
| 01-15 | Check/Payment | 60.00 | 60.00 | 120.00 | 120.00 |
| 01-20 | Check/Payment | 40.00 | 40.00 | 160.00 | 160.00 |

01-21 FROZEN CASH BALANCE PER 01-15

| TRANSACTION WITHDRAWN | | | | (60.00) | 160.00 |
|---|---|---|---|---|---|
| 01-23 | Check/Payment | 20.00 | 20.00 | 120.00 | 180.00 |
| 01-28 | Check/Payment | 80.00 | 80.00 | 200.00 | 260.00 |

02-01 FROZEN CASH BALANCE IS DEBITED TO PARTIALLY
CREDIT CHECK OR ELECTRONIC BILL PAYMENT DEBIT
AMOUNTS

| | | | | |
|---|---|---|---|---|
| TOTAL | 260.00 | 60.00 | 0 | 60.00 |

On 01-21, the $60 amount corresponding to the 01-15 transactions is withdrawn from the frozen cash balance, resulting in a $60 shortfall in the 02-01 frozen cash balance debiting/initial credit balance crediting, whereby the $60 remains as an open item to be paid later by the payer. Conventional wisdom dictates that a “frozen” balance remains frozen until the intended “unfreezing” and/or transfer debiting occurs; however, it is disclosed herein that, in given embodiments, account providers can optionally allow where frozen balances can be “tampered” with, either manually or automatically, for any purpose, and by any implementation (a manual unfreezing/withdrawal by the payer who has a higher need for the cash, an automatic unfreezing/withdrawal by the account provider to cover check overdrafts, an automatic unfreezing/withdrawal by the account provider to pay account related fees, etc.), which negates the traditional intended purpose of a frozen balance. A frozen cash balance can be part of at least one unfrozen cash balance, and/or the frozen cash balance can comprise at least one balance entirely separate from the at least one unfrozen cash balance. Also, whether or not frozen cash balances, or frozen portions of cash balances, are interest bearing, is an option to be determined, such as by those implementing the disclosed methods such as the account provider.

Check or Electronic Payments—Transactions Automatically and Individually Paid in-Turn, then Automatically and Individually Readjusted in-Turn with Plural Transaction Automatically Paid Together at a Given Time Interval

This unique hybrid for check or electronic payments comprises where individual checks/payments on the initial credit balance are automatically paid, then automatically readjusted, then the plurality of checks/payments are cumulatively and automatically paid together by the frozen cash balance comprising the readjusted cash balance at a given later time interval. The readjusted credit balance can be the initial credit balance, and/or at least one different balance entirely, just as the readjusted frozen cash balance amounts can comprise the initial cash balance, and/or at least one different balance entirely. This hybrid embodiment has a readjustment function a core aspect of its operation.

| | | | | | Readjusted |
|---|---|---|---|---|---|
| | | | | Cash | Frozen |
| | | | Credit Bal | Bal Amt | Cash |
| Date | Description | Amount | Debit | Paid/Unpaid | Balance |
| 01-02 | Check/Payment | 40.00 | 40.00 | 40.00 | 40.00 |
| 01-09 | Check/Payment | 20.00 | 20.00 | 20.00 | 60.00 |
| 01-15 | Check/Payment | 60.00 | 60.00 | 60.00 | 120.00 |
| 01-20 | Check/Payment | 40.00 | 40.00 | 40.00 | 160.00 |
| 01-23 | Check/Payment | 20.00 | 20.00 | 20.00 | 180.00 |
| 01-28 | Check/Payment | 80.00 | 80.00 | 80.00 | 260.00 |
| 01-31 | FROZEN CASH BALANCE IS DEBITED TO CREDIT | | | | |
| | CHECK OR ELECTRONIC BILL PAYMENT DEBIT | | | | |
| | AMOUNTS | | | | |
| | TOTAL | 260.00 | 0 | 0 | 0 |

In this hybrid embodiment, and as explained in the prior adjacent “paid together” section regarding “unfreezing” the frozen cash balance, the frozen cash balance that is debited to credit the check or electronic payment credit balance debit amounts can, depending on the embodiment, be fully or partially “unfrozen” and withdrawn by either the account provider or the payer for any reasons; or, a given embodiment could prohibit such unfreezing. Unfrozen funds that are withdrawn and not somehow restored will result in open credit balance items that the payer will be expected to pay later.

### End-User Security—Fraud Assistance

An especially salient advantage to the “crebit” methods of check or electronic payments pertains to end-user security. Normally, when a checkbook is stolen, fraudulent checks generally present difficulties to the rightful account owner. Also, once the fraudulent checks are reported, it often takes weeks for the cash to be restored to the account owner, and for non-fraudulent bounced check issues to be resolved. With the “crebit” methods, problems regarding stolen checks that result in fraudulent checks can be somewhat minimized, in that any fraudulent “paid in-turn” checks can be automatically readjusted to restore cash balances, and any fraudulent “paid together” checks can have funds automatically unfrozen or unallocated, also to restore cash balances.

With regards to electronic payments, even though fraudulent electronic payments are not indicated as being particularly problematic, erroneous electronic payments can and do occur, especially where a merchant, product, or service provider basically “pulls” funds from a payer's electronic payment account. In the following example, on 01-21, a payer checks his check/payment account, and notices two debits (one on 01-15, the other on 01-20) that have no ready recognition or explanation. After further investigation, the payer concludes that the debits were erroneous electronic payments “pulled” by one of the payer's service providers, and takes corrective measures by performing manual readjustments on the two debits, which results in the payer's cash account being credited, and where the erroneous debits convert to open items on the credit balance, and notifying the service provider of the erroneous activity. The service provider investigates, acknowledges the problem and on 1-22 “pushes” back the “pulled” payments, which credits and essentially zeros out the erroneous open credit balance items.

| | | | | Amt | |
|---|---|---|---|---|---|
| | | | | Debited | |
| | | | Credit Bal | Frm | Net Effect |
| Date | Description | Amount | Debit | Cash Bal | Credit Bal |
| 01-02 | Check/Payment | 40.00 | 40.00 | 40.00 | 0 |
| 01-09 | Check/Payment | 20.00 | 20.00 | 20.00 | 0 |
| 01-15 | Check/Payment*** | 60.00 | 60.00 | 60.00 | 0 |
| 01-20 | Check/Payment*** | 40.00 | 40.00 | 40.00 | 0 |
| 01-21 | 01-15 Erroneous Debit Manually | | | (60.00) | 60.00 |
| | Readjusted | | | | |
| 01-21 | 01-20 Erroneous Debit Manually | | | (40.00) | 40.00 |
| | Readjusted | | | | |
| 01-22 | Service Provider Removes Erroneous Credit Item | | | | (100.00) |
| | Amounts | | | | |
| 01-23 | Check/Payment | 20.00 | 20.00 | 20.00 | 0 |
| 01-28 | Check/Payment | 80.00 | 80.00 | 80.00 | 0 |
| | TOTAL | 160.00 | 160.00 | 160.00 | 0 |

***ERRONEOUS PAYMENT ITEMS

Thanks to the manual readjustment procedure, the payer in the above example did not have to wait for any action by the erroneous service provider before the payer's cash balance was credited for the erroneous deduction, possibly sparing the payer from issues that can arise from unexpectedly reduced cash balance levels. Such is useful as a partial but very helpful remedy for a problem resolution that could potentially take days, if not weeks.

This next example will illustrate how an automatic readjustment functions within the context of fraudulent activity. For clarification purposes, all activity in this example will center around check drafts. Here, the payer has a cash account with an balance on 01-01 of $1000.

| | | | | Amt | |
|---|---|---|---|---|---|
| | | | | Debited | |
| | | | Credit Bal | Frm | Net Effect |
| Date | Description | Amount | Debit | Cash Bal | Cash Bal |
| 01-01 | Open Cash Balance Amount | | | | 1,000.00 |
| 01-02 | Check | 40.00 | 40.00 | 40.00 | 960.00 |
| 01-09 | Check | 20.00 | 20.00 | 20.00 | 940.00 |
| 01-12 | Fraudulent Check | 1,000.00 | 1,000.00 | 1,000.00 | (60.00) |

| 01-12 | 01-02 and 01-09 Check-Auto Unpay | | (60.00) | 0 |
|---|---|---|---|---|
| 01-12 | E-mail Notice sent to Payer regarding Auto Unpay | | | |
| 01-12 | Account Provider confirms Fraud closes Account, | | | |
| | and/or provides New Account Number | | | |
| 01-12 | Account Provider | (1,000.00) | (1,000.00) | 1,000.00 |
| | unpays Fraudulent | | | |
| | Check restoring | | | |
| | Cash Balance, | | | |
| | Removes Credit Bal Debit | | | |

| | | | |
|---|---|---|---|
| 01-12 | Account Provider debits Cash Balance | 60.00 | 940.00 |
| | for 01-02 and 01-09 Transactions, | | |

On 01-02 and 01-09, incoming checks are paid. On 01-12, a fraudulent $1,000 check comes in that is not only large enough to deplete the cash balance, but is large enough to trigger automatic readjustments of the 01-02 and 01-09 checks as well. That same day, the payer notices an E-mail regarding the readjustments, investigates and sees the fraudulent charge, and notifies the account provider. The account provider confirms fraud, and either closes the account, and/or provides a new account number, then subsequently credits the cash balance for $1000 and debits the credit balance for $1000, removes the $1000 debit to the credit balance due to the fraudulent check, and debits the cash balance for $60 for the 01-02 and 01-09 transactions. Now, had the customer not noticed or heeded the 01-12 E-mail notice regarding the automatic readjustment, it is possible that any later incoming checks could trigger a partial, or even a full, automatic readjustment of the fraudulent $1000 charge, where the E-mail notification would surely get the payer's attention due to the large amount involved. What is most remarkable about this is that said later incoming checks could have been covered with the automatic readjustment instead of bouncing; or, due to the unique qualities of the embodiment illustrated in this particular example, the incoming checks could have simply been honored due to debiting the example's credit balance, instead of a traditional cash balance. Also, after such fraudulent check occurrence, the payer could have “manually” performed a readjustment on the fraudulent transaction amount himself, and transfer or withdraw some, most, or all of the cash balance credited by the readjustment.

The invention provides an aspect wherein said file maintenance functions enable readjustment or revision with regard to how said given transaction is debited among said at least two account balances on a post real-time basis after a transaction is posted or otherwise consummated, either by readjusting global parameters, or by revising actual amounts. The invention further provides an aspect wherein said file maintenance functions enable readjustment or revision with regard to how said given transaction is debited among said at least two account balances on a post real-time basis after a transaction is posted or otherwise consummated, either by readjusting global parameters, by revising actual amounts, or by specifying an amount to be readjusted, where said readjustment comprises a full or partial amount of said given transaction. The invention further provides such a method wherein said given transaction debiting an initial credit balance readjusts to debit at least one cash balance, and/or at least one additional credit balance, thereby crediting or restoring said initial credit balance. The invention provides an aspect wherein said restoring of said initial credit balance is by use of funds from said cash balance. The invention provides an aspect wherein said initial credit balance is restored to a pretransaction amount. The invention provides an aspect wherein said given transaction debiting an initial cash balance readjusts to debit at least one credit balance, and/or at least one additional cash balance, thereby crediting or restoring said initial cash balance, whereby said readjustment to said initial cash balance offers a benefit for the issuer of the global account by increasing the risk of default for said global account by the end user, whereby said issuer can charge higher transaction or account fees. The invention provides an aspect wherein said readjustment comprises transaction specific readjustments and/or amount specific readjustments. The invention provides an aspect wherein an end user may make any number of said readjustment(s) comprising said transaction specific adjustments and/or said amount specific readjustments back and forth between any of the said at least two balances. The invention provides an aspect wherein said readjustment comprising transaction specific readjustments and/or amount specific readjustments comprise an enhancement to accounts that use a singular balance, such as debit card accounts, ATM card accounts, checking accounts, and the like that comprise a singular cash balance; and, credit card accounts, lines of credit, and the like that comprise a singular credit balance. The invention provides an aspect wherein said readjustment comprising transaction specific readjustments and/or amount specific readjustments can be utilized to remedy overdraft conditions.

The invention further provides a method for readjustment or revision of the allocation of balances to cover at least one transaction debited from at least one first financial account, after said debited transaction is posted or otherwise consummated, comprising accessing said at least one first financial account from which said transaction was debited; and readjusting or revising said allocation of balances to cover said debited transaction using at least one preset parameter or at least one other parameter relating said at least one first financial account to at least one other account balance from at least one other second financial account by at least one step selected from readjusting at least one parameter relating the amounts in at least one of said first and second financial accounts to cover said debited transaction amount; revising at least one of said actual amounts in at least one of said first and second financial accounts to cover said debited transaction amount; or specifying at least one amount in at least one of said at least one first and second financial accounts to be readjusted to cover said debited transaction amount; wherein said readjustment or revision comprises at least a partial amount of said transaction debited from said first financial account.

The invention provides an aspect wherein said given transaction debiting an initial credit balance readjusts to debit at least one cash balance, and/or at least one additional credit balance, thereby crediting or restoring said initial credit balance. The invention provides an aspect wherein said given transaction debiting an initial cash balance readjusts to debit at least one credit balance, and/or at least one additional cash balance, thereby crediting or restoring said initial cash balance, whereby said readjustment to said initial cash balance offers an unexpected result and benefit for the issuer of the global account by increasing the risk of default for said global account by the end user, thus enabling said issuer to justify and charge higher fees. The invention provides an aspect wherein said readjustment comprises transaction specific readjustments and/or amount specific readjustments. The invention provides an aspect wherein an end user may make any number of said readjustment(s) comprising said transaction specific adjustments and/or said amount specific readjustments back and forth between any of the said at least two balances. The invention provides an aspect wherein said readjustment comprising transaction specific readjustments and/or amount specific readjustments comprise an enhancement to old and well known embodiments of accounts that use a singular balance, such as debit card accounts, ATM card accounts, checking accounts, and the like that comprise a singular cash balance; and, credit card accounts, lines of credit, and the like that comprise a singular credit balance. The invention provides an aspect wherein said readjustment comprising transaction specific readjustments and/or amount specific readjustments can be utilized to remedy overdraft condition. The invention provides an aspect wherein said transaction comprises the use of a financial card. The invention provides an aspect wherein said transaction comprises a cash withdrawal. The invention provides an aspect wherein said transaction comprises the use of a draft. The invention provides an aspect wherein said transaction comprises the use of an electronic or wire payment.

A powerful feature of the transaction processor is where a given transaction that is already posted may be switched from one already debited balance to another balance. An instance is where an end user desires that a given transaction debits at least one account balance in a different manner than what the transaction processor, per preset parameters, did initially; e.g., where an end user wishes to revise or readjust, say, a given $35 transaction so the transaction debits a cash balance that credits or restores the initial debiting of a credit balance. This feature can be accomplished manually by the end user, preset by the end-user or automatically use preset parameters, between cash and/or credit accounts, e.g., where a ratio and/or threshold amount is specified between one or more cash balances and credit balances, or where cash debit card users can use one or more credit balances for overdraft protection.

The following example shows a list of posted transactions where 50% of the transaction amount debited a cash balance, while the remaining 50% debited a credit balance.

| Date | Description | Amount | Cash | Credit |
|---|---|---|---|---|
| 01-02 | Restaurant | 48.00 | 24.00 | 24.00 |
| 01-03 | Gasoline | 21.00 | 10.50 | 10.50 |
| 01-05 | Shoe Store | 36.00 | 18.00 | 18.00 |
| 01-06 | Supermarket | 63.00 | 31.50 | 31.50 |
| 01-14 | Gasoline | 15.00 | 7.50 | 7.50 |
| 01-18 | Appliance Store | 750.00 | 375.00 | 375.00 |

When viewing the postings on 01-26, the end user determines that he would like to have more cash in his global account, and in making the determination feels that he would like to revise the 01-18 Appliance Store purchase so that the entire $750 debits the credit balance, which will return the $375 cash that was previously debited from his cash balance.

To perform this operation, the end user clicks on, or otherwise identifies using any method, the 01-18 Appliance Store transaction, highlights by clicking on the $375 cash in the cash debit column, and enters zero. The transaction processor checks the credit balance, sees that the credit balance can adequately handle an additional $375 debit, and automatically readjusts the debit on the credit balance to read $750. In essence, the end user can enter an amount greater than zero, which would still leave some residual amount debiting the cash balance for the 01-18 transaction, and would readjust the debit to the credit balance accordingly. While in most cases it is desirable for the transaction processor to make the amount readjustments automatically in response to a revision entered by the end user, there could be embodiments where more than one adjustment amount could be entered manually, with the transaction processor then verifying that the total correctly adds up and then checking the account balance(s) to see if the account balance(s) have the resources to allow the change before the readjustment is permitted. While such embodiments comprising manual entries can be used for global accounts comprising only two account balances, such manual entry capabilities are especially useful for embodiments comprising three or more account balances, where a readjustment to one account balance by the end user requires a non-obvious offset using at least one of the two or more remaining accounts. For example, if an end user wishes to make a readjustment that frees up $100 in one account balance, and has a choice of using two other account balances to offset the $100 amount, how that $100 is taken from the two remaining account balances is non-obvious, and thus requires the end user to actually specify the desired amount change(s) to either or both of the two remaining account balances. The example mentioned earlier in the paragraph is as follows:

| | | | | |
|---|---|---|---|---|
| Date | Description | Amount | Cash | Credit |

| | | | | |
|---|---|---|---|---|
| 01-18 | Appliance Store | 750.00 | 0 | 750.00 |

The end result is where the end user now has an extra $375 cash balance thanks to the readjustment. It is very important to keep in mind that the $375 is not a cash advance; rather, it is merely a restoration of a prior cash balance. There are no real implications here with regard to back interest. Assuming a grace period is in place, there is a chance that the extra $375 debit to the credit balance will be paid off before interest is assessed. In the event that the grace period does not apply, then the card issuer can charge interest on the extra $375 from the date that the credit balance is debited by the extra $375. Whether or not a feature fee, a per-use fee, or a percentage of the readjustment amount is charged for this end user readjustment feature is basically up to the card issuer/account provider. Keep in mind that while a singular transaction was highlighted and readjusted in the above example, it is possible to perform such a function on more than one transaction, either one at a time, or simultaneously. Also, an important aspect of this disclosure is where transactions that are readjusted from debiting, say, a cash balance to a credit balance, thus increasing the amount of the cash balance, can theoretically be readjusted or switched back and forth (from credit back to cash and vice-versa, or switched back and forth between any of the balances in global account embodiments comprising more than two balances) any number of times without limit, using full and/or partial amounts. However, in practice, a global account provider could ultimately seek to place limits on its end users with regards to the number or nature of such readjustments or switches. In illustrating a residual, or partial, amount transfer mentioned earlier, if the end user prefers to free up only an additional $200 of the consumed cash balance instead of the full $375 cash amount used for the 01-18 transaction, the end user may do so. As a result, referring to the prior example, the 01-18 $750 appliance store purchase debits the cash balance for a revised amount of $175, thus freeing up $200 cash from the original $375 debit to the cash balance, and the debit to the credit balance is increased by the $200 amount, so now the readjustment debits the credit balance for $575 instead of the original $375 amount. Furthermore, if an end user subsequently chooses to free up all or part of the remaining $175 debit to the cash balance, it is certainly within the scope of this disclosure to permit such additional readjustment.

| Date | Description | Amount | Cash | Credit |
|---|---|---|---|---|
| 01-18 | Appliance Store | 750.00 | 175.00 | 575.00 |

What happens if the opposite were to occur, where the end user wants to free up more of the credit balance? On 01-26, the end user clicks on the 01-18 Appliance Store transaction, highlights by clicking on the $375 credit balance debit column, and enters zero. The transaction processor checks the cash balance, sees that the cash balance can adequately handle an additional $375 debit, and automatically readjusts the debit on the cash balance to read $750, while at the same time is crediting the credit balance by $375.

| Date | Description | Amount | Cash | Credit |
|---|---|---|---|---|
| 01-18 | Appliance Store | 750.00 | 750.00 | 0 |

In this situation, there could be implications here with regards to back interest. If a grace period applies, then no back interest should be due; however, if a grace period does not apply, then there are 8 days of back interest that could still be due. Being that the transaction posted back on 01-18, and the change was made on 01-26, the customer could be charged 8 days interim interest on the $375 that was borrowed from the credit balance and paid to the appliance store merchant. In such a case it could be anyone's guess on how a card issuer/account provider would view such a situation, especially if the card issuer/account provider is earning revenue all along on a long-standing and sizable cash balance belonging to the customer that was the source of the $375 used to credit the customer's credit balance.

It is also possible with the transaction processor to highlight a grouping of posted transactions, and reset any of the global parameters such as ratio, amount threshold, remainder threshold, etc., and have all the posted transactions readjust.

For instance, instead of the transactions debiting the cash and credit balances 50%-50%, as the example below, the end user can highlight, say, the last four transactions . . .

| Date | Description | Amount | Cash | Credit |
|---|---|---|---|---|
| 01-02 | Restaurant | 48.00 | 24.00 | 24.00 |
| 01-03 | Gasoline | 21.00 | 10.50 | 10.50 |
| 01-05 | Shoe Store | 36.00 | 18.00 | 18.00 |
| 01-06 | Supermarket | 63.00 | 31.50 | 31.50 |
| 01-14 | Gasoline | 15.00 | 7.50 | 7.50 |
| 01-18 | Appliance Store | 750.00 | 375.00 | 375.00 |

Then reset the global parameters so the highlighted transactions are readjusted to where the 50%-50% ratio is replaced with, say, a remainder threshold where transaction amounts up to $20 debit the cash balance, and remainder amounts above $20 debit the credit balance. The resulting account debiting of the posted transactions, assuming adequate account balances, are as follows:

| Date | Description | Amount | Cash | Credit |
|---|---|---|---|---|
| 01-05 | Shoe Store | 36.00 | 20.00 | 16.00 |
| 01-06 | Supermarket | 63.00 | 20.00 | 43.00 |
| 01-14 | Gasoline | 15.00 | 15.00 | 0 |
| 01-18 | Appliance Store | 750.00 | 20.00 | 730.00 |

The net change to the two account balances is where the cash balance is credited $357, while the credit balance is debited $357. As mentioned earlier, the credited cash is a restoration of what was in the cash balance, which is good for the card issuer/account provider, being that the card issuer/account provider makes money on both the cash parked in the account, and on the increased credit usage. Resetting the parameters globally may comprise any of the parameters, such as ratio, amount threshold, remainder threshold, etc.

Finally, a question here is whether the end user can make these readjustments after the billing cycle closes. It is certainly possible for the transaction processor to enable posted transactions to remain accessible for readjustment after the billing cycle closes, but it is not without difficulties. One consideration includes system capabilities. Another consideration involves where end users that carry a large credit balance due can become especially confused by the shear number of past transactions presented, which could tax customer services resources considerably. While there is certain value to being able to make readjustments to transactions up to the close of the billing cycle, the value of offering such accommodations after the close of the billing cycle certainly diminish, while the difficulties in offering such post-billing cycle readjustments certainly increase. Nonetheless, it is disclosed that an end user can make post-billing cycle readjustments, should the offering card entity/account provider choose to allow it.

Furthermore, it is possible with the transaction processor to specify a readjustment using a specific amount, so specific transactions will automatically readjust according to, say, a desired dollar amount. An automatic readjustment may use any method in order to effect the readjustment such as FIFO (first in, first out), LIFO (last in, first out), lowest value transaction first, highest transaction value first, partial amounts of several transactions, etc. In the following example, an end user paid a total of $933.00 debiting only the cash balance as follows:

| Date | Description | Amount | Cash | Credit |
|---|---|---|---|---|
| 01-02 | Restaurant | 48.00 | 48.00 | 0 |
| 01-03 | Gasoline | 21.00 | 21.00 | 0 |
| 01-05 | Shoe Store | 36.00 | 36.00 | 0 |
| 01-06 | Supermarket | 63.00 | 63.00 | 0 |
| 01-14 | Gasoline | 15.00 | 15.00 | 0 |
| 01-18 | Appliance Store | 750.00 | 750.00 | 0 |
| | TOTAL | 933.00 | 933.00 | 0 |

Subsequently, the end user lets the transaction processor know that the end user wants $300.00 of the $933.00 back in cash, where the readjustment debits the credit balance and credits the cash balance. In this instance, the end user really doesn't care which transactions are affected by the readjustment; rather, the end user is solely interested in the net effect of having an additional $300.00 credit the cash balance. As mentioned above, the transaction processor may select which transactions are affected by any method. To illustrate the following example, FIFO (first in, first out) will be used, so of the six transactions listed below, all of the first five and part of the sixth transaction will be readjusted, where the total readjustments yield the $300 credit to the cash balance, and a total debit amount of $300 to the credit balance.

| Date | Description | Amount | Cash | Credit |
|---|---|---|---|---|
| 01-02 | Restaurant | 48.00 | 0 | 48.00 |
| 01-03 | Gasoline | 21.00 | 0 | 21.00 |
| 01-05 | Shoe Store | 36.00 | 0 | 36.00 |
| 01-06 | Supermarket | 63.00 | 0 | 63.00 |
| 01-14 | Gasoline | 15.00 | 0 | 15.00 |
| 01-18 | Appliance Store | 750.00 | 633.00 | 117.00 |
| | TOTAL | 933.00 | 633.00 | 300.00 |

In this next embodiment, it is possible to make a readjustment that is not transaction specific, that is, where one or more specific transactions are readjusted, but rather where the readjustment is amount specific. In the example below, the end user made a total of $933.00 of purchases using the cash balance. Here, the account issuer can enable the end user to credit the end user's cash balance (restoring cash to the cash balance while debiting the credit balance) without having to involve any specific transactions whatsoever. In this instance, the transaction processor sees that $933.00 of purchases were made by debiting the cash balance, and so allows the end user to readjust up to $933.00, resulting in a credit to the cash balance, and a debit to the credit balance. The up to $933.00 debit to the credit balance could simply be acknowledged as a lump-sum amount, and not as a listing of readjusted transactions, although the issuer can display the lump-sum amount eligible for readjustment (and/or the amount that has already been readjusted), as well as maintaining the option of listing the specific transactions that were affected by the readjustment.

| Date | Description | Amount | Cash | Credit |
|---|---|---|---|---|
| 01-02 | Restaurant | 48.00 | 48.00 | 0 |
| 01-03 | Gasoline | 21.00 | 21.00 | 0 |
| 01-05 | Shoe Store | 36.00 | 36.00 | 0 |
| 01-06 | Supermarket | 63.00 | 63.00 | 0 |
| 01-14 | Gasoline | 15.00 | 15.00 | 0 |
| 01-18 | Appliance Store | 750.00 | 750.00 | 0 |
| | TOTAL | 933.00 | 933.00 | 0 |

“END USER HAS $933.00° F. CASH BALANCE PURCHASES THAT ARE AVAILABLE FOR READJUSTMENT ONTO THE CREDIT BALANCE”

Per the above, should the end user choose to make an amount specific readjustment of $400.00 of the $933.00 cash balance purchases, where the readjustment credits the cash balance and debits the credit balance for the $400.00 amount, and the end user has a $533.00 remainder that can still be readjusted, text may be modified as follows:
“END USER HAS $533.00° F. CASH BALANCE PURCHASES THAT ARE AVAILABLE FOR READJUSTMENT ONTO THE CREDIT BALANCE—END USER HAS A $400.00 TOTAL MISCELLANEOUS DEBIT TO THE CREDIT BALANCE AS A RESULT OF PRIOR READJUSTMENT(S)”

It is especially important to be reminded that any readjustments, comprising readjustments such as transaction specific readjustments or amount specific readjustments, where the end result thereof enables the end user to basically pull cash out of the end user's transaction activity, is not the same as a “cash advance” against an credit balance, because the cash that the end user pulls out is cash that originally belonged to the end user anyway. In the same way that an end user may theoretically make any number of transaction specific readjustments without limit (as mentioned earlier), the end user may make any number of amount specific readjustments back and forth between any of the balances comprising the at least two balances of the global account. It is conceivable that an end user could wish to actually withdraw more cash than the amount available via a readjustment. Pertaining to the above example, if an end user wished to have a cash withdrawal totaling $1000.00, and wished to readjust the entire $933.00 transaction activity to free up the cash that the end user used for the prior purchases, then the $1000.00 cash withdrawal could be realized by readjusting the $933.00 purchases, and then taking out the additional $67.00 in the form of a “cash advance” against the credit balance. The desired cash withdrawal would still show a total debiting of the credit balance(s) for $1000.00; however, only $67.00 of the $1,000.00 debit against the credit balance(s) would be due to an actual “cash advance”. As mentioned earlier, the transaction processor functions with any type of security/verification and/or system routing, such as PIN-based ACH or EFT environments. In embodiments using ACH and/or EFT access, transaction specific readjustments, and/or an amount specific readjustments can comprise where said readjustments include crediting an cash balance by debiting a line of credit, or debiting an credit balance, where the issuer considers the readjustment that pulls cash out as a debit to the line of credit, or as a “cash advance” against the credit balance, and charge the customer interest relating to the line of credit, or additional “cash advance” fees and higher interest rates relating to debiting the credit balance. Note that it is possible for an account provider to allow use of the credit balance in such embodiments in exchange for more traditional credit balance use terms (sans additional “cash advance” fees and higher interest rates), for whatever reason(s) or considerations.

Whether by using a transaction specific readjustment, and/or an amount specific readjustment, the ability to reclaim cash from purchase transactions already made (where the purchase transactions originally debited a cash balance, and are readjusted to debit a credit balance, thereby crediting or restoring funds back to a cash balance) offers an unexpected result and potentially very lucrative benefit for issuers of the global account by greatly increasing the risk of default for the entire global account by the end user, which in turn enables the issuer to justify and charge higher fees, especially in relation to those fees earned that are associated with purchase transactions, such as interchange fees. Financial card account issuers charge relatively higher fees for transactions performed with their credit cards (which debit a credit balance) than for transactions performed with their debit cards (which debit a cash balance). This is due to the fact that credit card accounts carry the risk of the end user defaulting on payment to the card issuer for charges made by the end user. An example is where an end user charges $10,000 on his credit card account, and then skips town without paying any of the principal or interest due on the account, thereby leaving the card issuer “holding the bag”. A typical debit card does not carry this risk due to the fact that the end user uses his own cash instead of a credit balance, so the risks that debit card issuers tend to have is in having to make restitution to an end user that was the victim of debit card fraud or theft, which tends to be a much smaller risk in dollar terms (and thus carries a smaller risk premium) than credit card account default risk. Thanks to this readjustment concept of the present disclosure, an end user of a global account can make purchase transactions using $10,000 of a cash balance in the global account, which is the end user's own money (and which, in a typical debit card account, carries no default risk to the card issuer); then, the end user can readjust the $10,000 in purchase transactions so the transactions debit a credit balance in the global account for the $10,000 amount, resulting where the cash balance that was originally used for the purchases is (re)credited for the $10,000 amount; then, the end user can withdraw the (re)credited $10,000 amount from the global account, and then default on the $10,000 debit to the credit balance, where the debit to the credit balance was created by the readjustment. It is in this way that an end user that uses only his own cash balance for a given purchase transaction can still present a default risk for the entire transaction amount to the provider of the global account. While the potential for higher fee revenue affects the merchants in a negative way, there are also unexpected results that benefit merchants as well. First, if an end user has a tendency to favor cash balances for purchases, the end user is likely to be less watchful of cash balance levels, and is therefore likely to spend more with a given merchant, if the end user has a readjustment mechanism or “safety valve” readily in place that enables transactions to be readjusted from a cash balance to a credit balance, being that the readjustment mechanism provides a remedy to potential cash balance shortfalls. Second, an end user that has a tendency to favor cash balances for purchases, but has an unexpected cash balance shortfall, now has the option of using the readjustment mechanism, rather than returning the purchased item to the merchant, resulting in fewer returned items for the merchant, and less running around for the end user.

Furthermore, and very importantly, the ability to perform readjustments comprising transaction specific readjustments, and/or an amount specific readjustments in order to reclaim cash from purchase transactions already made, with or without the capability to make any number of readjustments back and forth between any of the balances, is disclosed as being highly and especially advantageous as an additional enhancement to old and well known embodiments of accounts that use a singular balance, such as debit card accounts, ATM card accounts, checking accounts, and the like that comprise a singular cash balance; and, credit card accounts, lines of credit, and the like that comprise a singular credit balance.

As discussed earlier, if the user has made a number of purchases debiting the cash balance, and does not have enough cash balance on hand to cover a demand draft (personal check that debits the cash balance), or an ATM cash withdrawal for that matter, a credit balance that is a part of the global account can issue a cash advance to cover the cash balance deficit (using “Rescue or Reject” or “Best Fit” criteria to access a credit balance obtain a cash advance for cash withdrawals). Such cash advances carry fees that end users may not like, so a cash overdraft due to a personal check, a desired ATM withdrawal, and the like can be remedied using a readjustment mechanism comprising transaction specific readjustments or amount specific readjustment described above. Here, an appropriate setting on the transaction processor can detect an overdraft condition, and perform a readjustment comprising a transaction specific readjustment or amount specific readjustment that converts debits to the cash balance into debits to the credit balance, thus producing cash in the amount necessary to cover the overdraft. While it is possible for a readjustment that addresses an overdraft condition to comprise a manual entry by the end user, a preferred embodiment is where the transaction processor, upon detection of the overdraft condition, performs the readjustment automatically. Readjustments correcting overdraft conditions can be seen in the following examples.

Here is an illustration of transaction activity where only the cash balance was used. For the purpose of these examples, let's assume that there is a zero cash balance remaining after these $933.00 of transactions have taken place, that the entire $933.00 amount is available for readjustment onto the credit balance, freeing up to $933.00 of the cash balance for whatever purposes, and that there is an adequate credit balance to handle any readjustments that are to take place.

| Date | Description | Amount | Cash | Credit |
|---|---|---|---|---|
| 01-02 | Restaurant | 48.00 | 48.00 | 0 |
| 01-03 | Gasoline | 21.00 | 21.00 | 0 |
| 01-05 | Shoe Store | 36.00 | 36.00 | 0 |
| 01-06 | Supermarket | 63.00 | 63.00 | 0 |
| 01-14 | Gasoline | 15.00 | 15.00 | 0 |
| 01-18 | Appliance Store | 750.00 | 750.00 | 0 |
| | TOTAL | 933.00 | 933.00 | 0 |

To the above transaction activity, a $40.00 debit to the cash balance is attempted. Remember that there is zero cash balance that is available for debiting. The $40.00 debit can be anything from a check hitting a checking account (where the cash balance is also used for check clearance as part of a checking account), an ATM cash withdrawal, etc. Rather than having the $40.00 check bounce, or the $40.00 ATM withdrawal be denied, and rather than having to rely on lines of credit or cash advances, a readjustment can be used to satisfy the overdraft condition as follows. Using a transaction specific readjustment on a FIFO basis (first in-first out, although any other basis or selection method may be used), the 01-02 restaurant entry, being the first transaction per the FIFO basis, is partially readjusted from the cash balance to the credit balance, where the cash balance is credited for $40.00 and the credit balance is debited for $40.00, which the end user will have to pay back at a future time. This $40.00 addition to the cash balance is used to satisfy the $40.00 overdraft condition in the cash balance.

| Date | Description | Amount | Cash | Credit |
|---|---|---|---|---|
| 01-02 | Restaurant | 48.00 | 8.00 | 40.00 |

THE 01-02 TRANSACTION WAS PARTIALLY READJUSTED TO SATISFY A $40.00 OVERDRAFT CONDITION TO THE CASH BALANCE

Now, an account issuer may choose to allow partial transaction readjustments for overdraft conditions, or could require that the entire transaction be readjusted. In an instance where the entire 01-02 transaction amount of $48.00 is required to be adjusted, the credit balance will be debited for $48.00, and the cash balance will be credited $48.00, which not only enables the $40.00 overdraft to be covered, but also leaves a remainder of $8.00 to be credited to the cash balance.

Keeping in mind that, per the above transaction activity, $933.00 is available for readjustment onto the credit balance, use of an amount specific readjustment to satisfy the same $40.00 overdraft condition can be seen by the following notation:
“END USER HAS A $40.00 DEBIT TO THE CREDIT BALANCE AS A RESULT OF READJUSTMENT(S) TO SATISFY OVERDRAFT(S) TO THE CASH BALANCE—END USER HAS $893.00 REMAINING OF CASH BALANCE CREDIT BALANCE”.

Again, the $40.00 that was readjusted onto the credit balance will have to be paid by the end user at a future time.

Readjustments to satisfy overdraft conditions per this disclosure have the capability to be quite flexible. Any credit balance(s) may be readjusted to satisfy overdraft conditions in any cash balance(s), and/or any other credit balance(s), whereas any cash balance(s) may be readjusted to satisfy overdraft conditions in any credit balance(s), and/or any other cash balance(s). It should be thoroughly understood that readjustments as a remedy for overdraft conditions is a very different method than merely using an unused portion of a balance for the same purpose (such as the “Best Fit” and “Rescue and Reject” methods disclosed earlier), in that readjustments comprising transaction specific readjustments (where at least one transaction is readjusted), and/or amount specific readjustments (where a transaction amount is readjusted), require an extra step or operation, that being the readjustment itself, before the resultant unused portion of a balance can be used to satisfy the overdraft condition.

As disclosed in the earlier readjustment section comprising transaction specific readjustments and amount specific readjustments, any transaction or transaction amount that debits an account balance can be automatically or manually readjusted, so when a transaction has been paid by debiting a cash balance (such as an automatic debit/payment with a standard debit card), by readjusting the transaction to an credit balance, it becomes readjusted, all without ever involving the merchant, or most if not all transaction processing intermediaries. In fact, in a standard debit card embodiment, where all the transaction items have already been automatically paid for by the actual end user, by enabling the addition and usage of at least one credit balance, the readjustment mechanism can readjust all or some of the transactions, whereby the transactions are moved over to the at least one credit balance(s) for payment at a future date. As disclosed in the earlier readjustment section, this enables the end user to free up cash for different purposes, such as an ATM or check withdrawal or to automatically (or even manually) address an overdraft condition to prevent an ATM withdrawal from rejecting, or a check from bouncing. In addition to new debit card embodiments, it is important to understand that any preexisting standard, separate or free-standing debit card account or embodiment can be subsequently modified and enhanced with the addition and enabling of at least one credit balance that will enable such readjustments comprising transaction specific readjustments and amount specific readjustments. A transaction that was paid using a cash balance, and then was subsequently readjusted, which results in the crediting of at least one cash balance (which may comprise the initial cash balance, and/or even at least one other cash balance), and a debiting of at least one credit balance that, like a credit card transaction, is paid at a future time.

The following example shows a standard debit card embodiment modified and enhanced with the addition and enabling of at least one credit balance that will enable readjustments to occur.

| | | Transaction | Cash | Readjustment | Credit Balance To |
|---|---|---|---|---|---|
| Date | Description | Amount | Bal Paid | Amt Unpaid | Be Repaid |
| 01-02 | Restaurant | 48.00 | 48.00 | 0 | 0 |
| 01-03 | Gasoline | 21.00 | 21.00 | 0 | 0 |
| 01-05 | Shoe Store | 36.00 | 36.00 | 0 | 0 |
| 01-06 | Supermarket | 63.00 | 63.00 | 63.00 | 63.00 |
| 01-14 | Gasoline | 15.00 | 15.00 | 15.00 | 78.00 |
| 01-18 | Appliance Store | 750.00 | 750.00 | 750.00 | 828.00 |

TRANSACTIONS FROM 01-06, 01-14, AND 01-18 ARE READJUSTED
(UNPAID), THUS CREDITING CASH BALANCE(S) FOR $828.00

| | | | | | |
|---|---|---|---|---|---|
| 01-24 | Gasoline | 18.00 | 18.00 | 0 | 0 |
| 01-30 | Restaurant | 33.00 | 33.00 | 0 | 0 |
| | TOTAL | 984.00 | 984.00 | 828.00 | 828.00 |

The transactions of January 6, January 14, and January 18 are readjusted, resulting in a readjusted amount of $828.00 that is credited to an cash balance (which may comprise the initial cash balance used to originally pay for the transactions, and/or even at least one other cash balance). As a result of the readjustment, an credit balance is debited for the $828.00 amount that is expected by the account issuer to be paid at a future date.

In fact, it is possible to advertise to the end user that such a large cash balance is available for use via a readjustment comprising a transaction specific readjustment and/or an amount specific readjustment. Furthermore, it is possible to turn on and off a readjustment function that automatically readjusts any transaction amounts by paying (crediting) the cash balance, or another cash balance comprising the debit card, and debiting at least one credit balance that is paid later. This readjustment mechanism is useful for automatically un-paying transactions to cover an overdraft; however, it is also extremely useful for un-paying potentially suspicious transactions, such as out-of-state or foreign transactions when coupled with capabilities comprising special identifier information such as merchant identifier information, location of transaction origination, etc., which will be explained later.

### Parameters

The logic of the presented parameter can be reduced basically down to “if/then” statements, such as “if the check or electronic payment is more than $40, then debit balance #2”. Such parameters can involve simple “if/then” instructions, simple “if’ instructions with complex “then” instructions, complex multi-conditional “if’ instructions with simple “then” instructions, or complex multi-conditional “if instructions with complex “then” instructions. An example of the later is: “if the check or electronic payment exceeds $40, and results in consumption of balance #1 remaining under $1000, then debit 50% of the check/payment amount from balance #1, 25% of the check/payment amount from balance #2, and 25% of the check/payment amount from balance #3; however, if the check is $40 or less, and results in consumption of balance #1 under $500, then debit 100% of the check/payment from balance #1—if neither of these condition sets apply, then debit balance #4 instead”.

### Credit Limit

With regards to check or electronic payments, an important matter concerns the credit limit comprising one or more credit balances that enable certain check or electronic payment embodiments. Being that myriad possibilities exist with regards to establishing, setting, or revising credit limit (s) on one or more credit balances, this disclosure places no specific limitations, or restrictions, whereby the account provider or balance provider is wide open to use any metric(s) for establishing, setting, or revising credit limit(s) that the account provider pleases, regardless of whether the credit limit(s) mirror or otherwise resemble the amount of the unfrozen and/or frozen cash balance(s); whether credit limit(s) track, somewhat exceed, greatly exceed, etc. any cash balance amounts; or, where credit limit(s) are totally or somewhat related, or totally or somewhat unrelated, to any cash balance amounts or cash balance parameters. With regards to allowing readjustments, while it is logical to allow such readjustments only within the constraints of a predetermined credit limit, regardless of whether such a credit limit is the same or different than the credit limit for a given credit balance, or is the same or different than the combined credit limit balance for a plurality of credit balances comprising the check/electronic payment account, this disclosure places no specific limitations, or restrictions regarding the subject of credit limits as applied to allowing or disallowing specific manual or automated readjustments.

Series and/or Parallel Transaction Movement

Per the embodiments presented above, transaction movement relating to check or electronic payments may comprise two distinct methods:

Where the transaction movement comprises the simple movement or shifting of a given transaction/transaction amount between two like-kind balances (from a credit balance to another credit balance, or from a cash balance to another cash balance); or, where the transaction movement comprises the actual crediting and/or debiting of a given transaction/transaction amount, which facilitates the movement of the transaction/transaction amount between either like-kind balances (from a credit balance to another credit balance), or non like-kind balances (from a credit balance to a cash balance, or vice versa).

A given embodiment may comprise either or both methods. Keeping this in mind, any of the disclosed embodiments, from the simple to the complex, may additionally comprise complex transaction movement routines that employ any number, or kind of extra balances (regardless of whether the balances are cash balances or credit balances, or in-house or out-of-house balances), in any order, whereby nearly infinite variations are possible. Furthermore, a given payment amount can be moved in series from one balance to another, and/or parallel through more than one balance simultaneously. These complex routines can easily take place without the end-user ever knowing or suspecting. For example, in a “crebit” check or electronic payment embodiment, a given incoming payment amount can be moved in series and/or parallel through any number, kind and order of balances before residing on the disclosed “initial credit balance” comprising the “crebit” embodiment. Also, in a given embodiment, a debit of any cash balances, regardless of whether they are frozen or not, can be moved in series and/or parallel through any number, type and order of balances, regardless of whether any of the balances are deemed “frozen” or not, before the debit ultimately credits another balance, such as an initial credit balance. The same applies to out-of-house credit or cash balances comprising a given embodiment, where a given payment amount moves through a complex routine of balances.

As an overview for a given embodiment, a given incoming payment amount debit or credit can move in series and/or parallel through any number, kind and order of balances before ultimately residing on the desired balance, as can an offsetting credit or debit. Readjustments can work the same way, whereby a given readjustment can have its crediting and debiting functions move in series and/or parallel through any number, kind and order of balances prior to consummation, as can any payment pertinent to a given readjustment. As a result, a complex transaction movement routine can comprise a few, a dozen, a hundred, etc., cash and/or credit balances, in any order, before a payment amount debit or credit ultimately resides on the desired initial or ultimate balance. Similarly, a complex transaction movement routine can comprise a few, a dozen, a hundred, etc., cash and/or credit balances, in any order, in order to perform an offsetting balance credit or debit, readjustment, etc.

With regards to this disclosure comprising the abstract, specification and claims, the terms “a,” “an,” “the” and similar referents used in the context of describing the invention (especially in the context of the following claims) are to be construed to cover both the singular and the plural, unless otherwise indicated herein or clearly contradicted by context.

All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventor for carrying out the invention. Of course, variations on these described embodiments will become apparent to those of ordinary skill in the art upon reading the foregoing description. The inventor expects skilled artisans to employ such variations as appropriate, and the inventor intends for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications in this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

1-13. (canceled)

14. A method for providing a readjustment between multiple account balances or accounts belonging to a payer for at least one completed payment transaction, said method comprising:
A. electronically providing by a transaction processor said at least one completed payment transaction paid by said payer, wherein said at least one completed payment transaction was paid using at least one first balance belonging to said payer, and wherein said at least one first balance was selected by said payer;
B. electronically identifying using a transaction processor said at least one completed payment transaction;
C. electronically debiting by a transaction processor at least one second balance belonging to said payer for at least one amount of said at least one completed payment transaction; and
D. electronically crediting by a transaction processor said at least one amount to at least one different balance belonging to said payer, wherein said at least one different balance is different than said at least one second balance;
wherein said readjustment provided in steps A through D: 1) changes the funding source for said at least one completed payment transaction from said at least one first balance belonging to said payer to said at least one second balance belonging to said payer, and 2) does not affect at least one payee of said at least one completed payment transaction; and wherein said at least one completed payment transaction remains paid by said payer using said at least one first balance when said readjustment is not applied to said at least one completed payment transaction.

15. A method according to claim 14, wherein said at least one completed payment transaction comprises at least one selected from the group consisting of: a completed electronic payment transaction, a completed check payment transaction, and a completed point of sale transaction.

16. A method according to claim 14, wherein said at least one different balance credited in step D comprises said at least one first balance.

17. A method according to claim 14, wherein said at least one different balance credited in step D does not comprise said at least one first balance.

18. A method according to claim 14, wherein said readjustment is automatically triggered by a transaction processor to cover balance overdrafts or account overdrafts, thereby preventing non-sufficient funds conditions from occurring, and thereby preventing the rejection of at least one selected from the group consisting of: check payment transactions, electronic payment transactions, point of sale transactions, and ATM withdrawals.

19. A method according to claim 14, wherein said readjustment is automatically triggered by a transaction processor to remedy at least one selected from the group consisting of: erroneous check payment transactions, fraudulent check payment transactions, erroneous electronic payment transaction amounts, fraudulent electronic payment transaction amounts, erroneous point of sale transactions, and fraudulent point of sale transactions.

20. A method according to claim 14, wherein said method enables an end user to electronically identify said at least one completed payment transaction in step B.

21. A method according to claim 14, wherein said readjustment enables an end user to prevent non-sufficient funds conditions from occurring, thereby preventing the rejection of at least one selected from the group consisting of: check payment transactions, electronic payment transactions, point of sale transactions, and ATM withdrawals.

22. A method according to claim 14, wherein a readjustment of an erroneous or fraudulent completed transaction is performed by an end user.

23. A method according to claim 14, wherein said at least one first balance belonging to said payer or said at least one different balance belonging to said payer comprises at least one selected from the group consisting of: at least one credit-based financial instrument and at least one cash-based financial instrument, wherein said at least one credit-based financial instrument comprises at least one selected from the group consisting of: a charge balance, a charge account, a revolving credit balance, a revolving credit account, a line of credit balance, a line of credit account, a charge card account, and a credit card account, wherein said at least one cash-based financial instrument comprises at least one selected from the group consisting of: a cash balance, a cash account, a demand deposit balance, a demand deposit account, a negotiable order of withdrawal balance, a negotiable order of withdrawal account, a checking balance, a checking account, a savings balance, a savings account, a money market balance, a money market account, a stored value balance, and a stored value account, and wherein said at least one first balance or said at least one different balance comprises at least one selected from the group consisting of: an in-house balance, an in-house account, an out-of-house balance, and an out-of-house account.

24. A method according to claim 14, wherein said at least one second balance belonging to said payer comprises at least one selected from the group consisting of: at least one credit-based financial instrument and at least one cash-based financial instrument, wherein said at least one credit-based financial instrument comprises at least one selected from the group consisting of: a charge balance, a charge account, a revolving credit balance, a revolving credit account, a line of credit balance, a line of credit account, a charge card account, and a credit card account, wherein said at least one cash-based financial instrument comprises at least one selected from the group consisting of: a cash balance, a cash account, a demand deposit balance, a demand deposit account, a negotiable order of withdrawal balance, a negotiable order of withdrawal account, a checking balance, a checking account, a savings balance, a savings account, a money market balance, a money market account, a stored value balance, and a stored value account, and wherein said at least one second balance comprises at least one selected from the group consisting of: an in-house balance, an in-house account, an out-of-house balance, and an out-of-house account.

25. A method according to claim 14, further comprising wherein only a portion of said at least one amount of said at least one completed payment transaction is electronically readjusted, wherein said portion is less than 100 percent of said at least one amount.

26. A method according to claim 14, wherein a transaction processor comprises at least one computer.

27. A method for providing a readjustment between multiple account balances or accounts belonging to a payer for at least one completed payment transaction, said method comprising:
A. electronically providing by a transaction processor said at least one completed payment transaction paid by said payer, wherein said at least one completed payment transaction was paid using at least one first balance belonging to said payer, and wherein said at least one first balance was selected by said payer;
B. electronically specifying using a transaction processor at least one amount, wherein said at least one amount pertains to a full or partial portion of a total amount of said at least one completed transaction;
C. electronically debiting by a transaction processor at least one second balance belonging to said payer for said at least one amount of said at least one completed payment transaction; and
D. electronically crediting by a transaction processor at least one different balance belonging to said payer for said at least one amount, wherein said at least one different balance is different than said at least one second balance;
wherein said readjustment provided in steps A through D: 1) changes the funding source for said at least one completed payment transaction from said at least one first balance belonging to said payer to said at least one second balance belonging to said payer, and 2) does not affect at least one payee of said at least one completed payment transaction; and wherein said at least one completed payment transaction remains paid by said payer using said at least one first balance when said readjustment is not applied to said at least one completed payment transaction.

28. A method according to claim 27, wherein said at least one completed payment transaction comprises at least one selected from the group consisting of: a completed electronic payment transaction, a completed check payment transaction, and a completed point of sale transaction.

29. A method according to claim 27, wherein said at least one different balance credited in step D comprises said at least one first balance.

30. A method according to claim 27, wherein said at least one different balance credited in step D does not comprise said at least one first balance.

31. A method according to claim 27, wherein said readjustment is automatically triggered by a transaction processor to cover balance overdrafts or account overdrafts, thereby preventing non-sufficient funds conditions from occurring, and thereby preventing the rejection of at least one selected from the group consisting of: check payment transactions, electronic payment transactions, point of sale transactions, and ATM withdrawals.

32. A method according to claim 27, wherein said readjustment is automatically triggered by a transaction processor to remedy at least one selected from the group consisting of: erroneous check payment transactions, fraudulent check payment transactions, erroneous electronic payment transaction amounts, fraudulent electronic payment transaction amounts, erroneous point of sale transactions, and fraudulent point of sale transactions.

33. A method according to claim 27, wherein said method enables an end user to electronically specify said at least one amount in step B.

34. A method according to claim 27, wherein said readjustment enables an end user to prevent non-sufficient funds conditions from occurring, thereby preventing the rejection of at least one selected from the group consisting of: check payment transactions, electronic payment transactions, point of sale transactions, and ATM withdrawals.

35. A method according to claim 27, wherein a readjustment of an erroneous or fraudulent completed payment transaction is performed by an end user.

36. A method according to claim 27, wherein said at least one completed payment transaction comprising said at least one amount is identified.

37. A method according to claim 27, wherein said at least one completed payment transaction comprising said at least one amount is not identified.

38. A method according to claim 27, wherein said at least one first balance belonging to said payer or said at least one different balance belonging to said payer comprises at least one selected from the group consisting of: at least one credit-based financial instrument and at least one cash-based financial instrument, wherein said at least one credit-based financial instrument comprises at least one selected from the group consisting of: a charge balance, a charge account, a revolving credit balance, a revolving credit account, a line of credit balance, a line of credit account, a charge card account, and a credit card account, wherein said at least one cash-based financial instrument comprises at least one selected from the group consisting of: a cash balance, a cash account, a demand deposit balance, a demand deposit account, a negotiable order of withdrawal balance, a negotiable order of withdrawal account, a checking balance, a checking account, a savings balance, a savings account, a money market balance, a money market account, a stored value balance, and a stored value account, and wherein said at least one first balance or said at least one different balance comprises at least one selected from the group consisting of: an in-house balance, an in-house account, an out-of-house balance, and an out-of-house account.

39. A method according to claim 27, wherein said at least one second balance belonging to said payer comprises at least one selected from the group consisting of: at least one credit-based financial instrument and at least one-cash based financial instrument, wherein said at least one credit-based financial instrument comprises at least one selected from the group consisting of: a charge balance, a charge account, a revolving credit balance, a revolving credit account, a line of credit balance, a line of credit account, a charge card account, and a credit card account, wherein said at least one cash-based financial instrument comprises at least one selected from the group consisting of: a cash balance, a cash account, a demand deposit balance, a demand deposit account, a negotiable order of withdrawal balance, a negotiable order of withdrawal account, a checking balance, a checking account, a savings balance, a savings account, a money market balance, a money market account, a stored value balance, and a stored value account, and wherein said at least one second balance comprises at least one selected from the group consisting of: an in-house balance, an in-house account, an out-of-house balance, and an out-of-house account.

40. A method according to claim 27, wherein a transaction processor comprises at least one computer.
